(19) United States
(12) Patent Application Publication
(10) Pub. No.: US 2010/0049629 A1
(43) Pub. Date: Feb. 25, 2010

(54) METHOD OF ENABLING A USER TO DRAW A COMPONENT PART AS INPUT FOR SEARCHING COMPONENT PARTS IN A DATABASE

(76) Inventors: Nainesh B Rathod, West Lafayette, IN (US); Jamie Tan, West Lafayette, IN (US); Karthik Ramani, West Lafayette, IN (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/196,340

(22) Filed: Aug. 22, 2008

(51) Int. Cl. G06Q 30/00; G06F 3/048

(52) U.S. Cl. 705/27; 715/764

(57) ABSTRACT

A method of receiving input image data for an image search engine includes providing a two-dimensional input image on a display screen, enabling a user to rotate the input image on the display screen about an axis that is non-perpendicular to a plane of the input image, and enabling the user to electronically draw modifications on the rotated input image.

### RELATED APPLICATIONS

This application claims the benefit of U.S. Provisional Application 60/776,061 filed Feb. 23, 2006, and PCT Application US2007062734 filed Feb. 23, 2007, each of which is hereby incorporated by reference herein.

### BACKGROUND OF THE INVENTION

1. Field of the Invention

The present invention relates to a method of creating a database of component parts and searching the database for a particular component part.

2. Description of the Related Art

Almost all machines, appliances, vehicles, etc. are formed of many component parts such as brackets, fasteners, connectors, frames and other parts that can be characterized by their visual appearance. If a particular part fails on a consumer product, the consumer may seek to replace the component part rather than replace the entire consumer product. In order to locate a source for the replacement part, the consumer may conduct a search on an Internet search engine by entering a keyword or descriptor of the component part.

A problem with conducting an online search for a component is that the consumer may not know the preferred descriptive term for the part he is searching for. This problem is compounded by the fact that there may be several possible terms that can be used to describe a particular component, and the component may not be indexed by any of the terms that the searcher is familiar with. Further compounding the problem is that the searcher's native language may not be the language by which the component parts are indexed. Yet another problem is that even if the searcher enters the best descriptor for the desired part, the search results may include many variations of the component, very few of which would fit the searcher's needs. For example, there are a great many variations of brackets, and thus a searcher would have to examine a large number of brackets provided in a computerized search in order to find a bracket that suits his needs.

Similar problems in locating parts are faced by a product designer. It is often less expensive to purchase existing components than to design and manufacture small quantities of a component from scratch. Although a product designer is more likely to be familiar with part descriptors than a consumer, a product designer must overcome many of the same problems described above in order to find an existing part that fits a particular application.

Still another problem is that each part supplier typically has its own web site. Thus, a searcher may have to search through a great many different web sites in order to find the part that he is looking for.

What is needed in the art is a method of developing a database of parts, and allowing the database to be searched in a way that avoids the problems discussed above, thereby enabling a user to more easily find a part having particular characteristics.

### SUMMARY OF THE INVENTION

The present invention provides a method of enabling a user to provide input image data for searching a database of image data. The user may draw, upload, or retrieve from the database an initial view of a part to be found in the database. The user may then modify the input image data for the search by rotating the initial view and doodling modifications on the rotated view to better represent the part being sought. The user may repeat the steps of rotating the image and modifying it by doodling as many times as he desires in order to further refine the input image data for the subsequent search of the database.

The present invention provides a method of creating a database of images of component parts by enabling vendors to upload electronic models of their associated parts including identification data. The electronic part models and associated identification data may be stored in the database for potential purchasers to search through. The potential purchasers may enter input image data, which may include doodled portions, into a search engine for comparison with the electronic part models stored in the database.

The invention comprises, in one form thereof, a method of receiving input image data for an image search engine. A two-dimensional input image is provided on a display screen. A user is enabled to rotate the input image on the display screen about an axis that is non-perpendicular to a plane of the input image. The user is also enabled to electronically draw modifications on the rotated input image.

The invention comprises, in another form thereof, a method of providing an electronic commercial showplace. A database of image data associated with component parts is provided. A plurality of vendors are enabled to upload image data to the database via a web site. The uploaded image data is associated with component parts that are sold by the vendors. A purchaser is enabled to enter image data onto a web site. The image data represents a component that the purchaser would like to buy. The database is searched for vendor image data matching the purchaser image data. A matching vendor image is displayed to the purchaser on the web site. Vendor information is displayed to the purchaser on the web site, the vendor information being associated with the matching vendor image data.

The invention comprises, in yet another form thereof, a method of providing an electronic commercial showplace. A database of image data associated with component parts is provided. Shape representations are extracted from three-dimensional models of vendors' component parts. The shape representations are stored in the database. A purchaser is enabled to enter image data onto a web site, the image data representing a component that the purchaser would like to buy. The database is searched for at least one shape representation matching the purchaser image data. A matching shape representation is displayed to the purchaser on the web site. Vendor information is displayed to the purchaser on the web site. The vendor information is associated with the matching shape representation.

The invention comprises, in still another form thereof, a method of providing an electronic commercial showplace. A database of image data associated with component parts is provided. Two-dimensional images are extracted from two-dimensional drawings of vendors' component parts. The two-dimensional images are stored in the database. A purchaser is enabled to enter image data onto a web site. The image data represents a component that the purchaser would like to buy. A three-dimensional shape search engine is used to search the database for at least one two-dimensional image matching the purchaser image data. A matching image is displayed to the purchaser on the web site. Vendor information is displayed to the purchaser on the web site. The vendor information is associated with the matching two-dimensional image.

The invention comprises, in a further form thereof, a method of providing an electronic commercial showplace. A database of image data associated with component parts is provided. Two-dimensional drawings of vendors' component parts are converted to three-dimensional image data. The three-dimensional image data is stored in the database. A purchaser is enabled to enter image data onto a web site. The image data represents a component that the purchaser would like to buy. The database is searched for three-dimensional vendor image data matching the purchaser image data. A matching three-dimensional vendor image is displayed to the purchaser on the web site. Vendor information is displayed to the purchaser on the web site. The vendor information is associated with the matching three-dimensional vendor image data.

The invention comprises, in a still further form thereof, a method of providing an electronic commercial showplace. A database of image data associated with component parts is provided. An index of part vendor web sites is compiled wherein the part vendors have granted permission to extract image data from the web sites. The image data is extracted from the vendor web sites. The image data is uploaded to the database via a host web site. The uploaded image data is associated with component parts that are sold by the vendors. A purchaser is enabled to enter image data onto a web site. The image data represents a component that the purchaser would like to buy. The database is searched for vendor image data matching the purchaser image data. A matching vendor image is displayed to the purchaser on the web site. Vendor information is displayed to the purchaser on the web site. The vendor information is associated with the matching vendor image data.

The invention comprises, in another form thereof, a method of receiving input image data for an image search engine, including providing a two-dimensional representation of a three-dimensional cubic shape on a display screen. The representation includes three faces oriented substantially perpendicular to each other. A user is enabled to draw a first orthographic view of an object onto a first of the faces, and a second orthographic view of the object onto a second of the faces.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is an exemplary page from a web site that may be used to implement one embodiment of the method of the present invention;

FIG. 2 is the web page of FIG. 1 with a doodled part entered into the canvas;

FIG. 3 is another page from the web site of FIG. 1 showing exemplary search results;

FIG. 4 is another page from the web site of FIG. 1 showing a part found in the database as a result of search based upon the doodled part of FIG. 2;

FIG. 5 is the web page of FIG. 4 after the part has been rotated ninety degrees by the user;

FIG. 6 is the web page of FIG. 5 after being revised by doodling by the user;

FIG. 7 is the web page of FIG. 6 after the part has been rotated ninety degrees by the user;

FIG. 8 is the web page of FIG. 7 after being revised by doodling by the user;

FIG. 9 is another embodiment of the web page of FIG. 4 after the part has been rotated ninety degrees by the user;

FIG. 10 is yet another web page showing component images that are stored in a database;

FIG. 11 is a web page having one of the component images of FIG. 10 entered onto a canvas;

FIG. 12 is the web page of FIG. 11 after being revised by doodling by the user;

FIG. 13 is still another web page showing component images from one of the categories of FIG. 10;

FIG. 14a is another web page for enabling a user to upload his own component image to the web site;

FIG. 14b is another view of the web page of FIG. 14a;

FIG. 14c is a web page showing an uploaded component image;

FIG. 14d is an engineering drawing that may be uploaded;

FIG. 14e is another view of the web page of FIG. 14a;

FIG. 14f is a web page showing uploaded component images;

FIG. 14g is a web page showing an enlarged view of one of the component images of FIG. 14f;

FIG. 15 is yet another web page displaying exemplary component images that are stored in the database;

FIG. 16a is a web page including advice to the user regarding how to doodle on the canvas;

FIG. 16b is another web page including advice to the user regarding how to doodle on the canvas;

FIG. 16c is yet another web page including advice to the user regarding how to doodle on the canvas;

FIG. 16d is still another web page including advice to the user regarding how to doodle on the canvas;

FIG. 17a is a web page advising the user about how he can add his parts to the database if he has electronic part files;

FIG. 17b is another web page advising the user about how he can add his parts to the database if he has electronic part files;

FIG. 17c is yet another web page advising the user about how he can add his parts to the database if he has electronic part files;

FIG. 18 is a web page describing the i-prowler software employed in the present invention for enabling a user to upload his own component images to the web site;

FIG. 19a is a web page listing questions about i-prowler software that may be frequently asked by users and their answers;

FIG. 19b is another web page listing questions about i-prowler software that may be frequently asked by users and their answers;

FIG. 20a is a web page-displaying privacy policies that may be employed in conjunction with the present invention;

FIG. 20b is another web page displaying privacy policies that may be employed in conjunction with the present invention;

FIG. 20c is yet another web page displaying privacy policies that may be employed in conjunction with the present invention;

FIG. 21 is a web page advising the user about how he can upload his parts directly to the database if he has electronic part files;

FIG. 22 is a web page enabling the supplier to enter his company information for storage in the database;

FIG. 23 is a web page explaining how Part Bin may be used in uploading a company's product information to the database;

FIG. 24a is a web page listing questions that may be frequently asked about Part Bin and the corresponding answers;

FIG. 24b is another web page listing questions that may be frequently asked about Part Bin and the corresponding answers;

FIG. 24c is yet another web page listing questions that may be frequently asked about Part Bin and the corresponding answers;

FIG. 24d is still another web page listing questions that may be frequently asked about Part Bin and the corresponding answers;

FIG. 24e is a further web page listing questions that may be frequently asked about Part Bin and the corresponding answers;

FIG. 25 is a web page enabling the supplier to add his company's URL to the web site's index;

FIG. 26a is a web page advising the supplier how to convert two-dimensional drawings to three-dimensional models for indexing;

FIG. 26b is another web page advising the supplier how to convert two-dimensional drawings to three-dimensional models for indexing;

FIG. 26c is yet another web page advising the supplier how to convert two-dimensional drawings to three-dimensional models for indexing;

FIG. 27 is a web page enabling the supplier to enter his company information for storage in the database, and to select an option for converting his two-dimensional drawings to three-dimensional solid models;

FIG. 28a is a web page advising the user how to add his parts/products to the database if he has two-dimensional drawings, has a two-dimensional catalog, and wishes to create an interactive three-dimensional web catalog;

FIG. 28b is another web page advising the user how to add his parts/products to the database if he has two-dimensional drawings, has a two-dimensional catalog, and wishes to create an interactive three-dimensional web catalog;

FIG. 28c is yet another web page advising the user how to add his parts/products to the database if he has two-dimensional drawings, has a two-dimensional catalog, and wishes to create an interactive three-dimensional web catalog;

FIG. 29 is a web page displaying a pricing sheet that may be used in conjunction with the present invention;

FIG. 30 is a web page enabling the supplier to enter his company information for storage in the database;

FIG. 31 is a web page advising a supplier how to add his parts/products to the database if he does not have electronic part files and is a standard part manufacturer;

FIG. 32 is a web page enabling a standard part manufacturer to select parts from a standard parts list;

FIG. 33 is a web page advising a supplier how to add his parts/products to the database if he does not have electronic part files and is a custom part manufacturer;

FIG. 34 is a web page enabling a custom part manufacturer to select parts from a custom parts list;

FIG. 35a is a web page advising a supplier how to advertise on the web site;

FIG. 35b is another web page advising a supplier how to advertise on the web site;

FIG. 35c is yet another web page advising a supplier how to advertise on the web site;

FIG. 35d is still another web page advising a supplier how to advertise on the web site;

FIG. 36 is a web page on which a user may order an advertisement on the web site of the present invention;

FIG. 37a is a web page displaying terms and conditions under which a user may advertise on the web site;

FIG. 37b is another web page displaying terms and conditions under which a user may advertise on the web site;

FIG. 38 is a web page enabling a user to send an email to his supplier in which the user refers the supplier to the web site;

FIG. 39 is a block diagram of one embodiment of a computer system of the present invention;

FIG. 40 is a web page showing the use of a cubic to enable a user to input three-dimensional image data;

FIG. 41 is the web page of FIG. 40 after a user has entered a front view of an object;

FIG. 42 is the web page of FIG. 41 after a user has added a right side view and a top view;

FIG. 43 is the web page of FIG. 42 after the user has rotated the right face toward him;

FIG. 44 is the web page of FIG. 41 after the user has rotated the right face toward him;

FIG. 45 is the web page of FIG. 41 after the user has rotated the top face toward him;

FIG. 46a shows a cubic with front, right, and top views of a table drawn therein;

FIG. 46b is a perspective view of the table drawn in FIG. 46a;

FIG. 47a shows a cubic with front, right, and top views of a cylinder drawn therein;

FIG. 47b is a perspective view of the cylinder drawn in FIG. 47a;

FIG. 48 is an exemplary page from another web site that may be used to implement another embodiment of the method of the present invention;

FIG. 49 is another page from the web site of FIG. 48 showing exemplary search results; and

FIG. 50 is another web page for enabling a user to upload his own component image to the web site.

Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

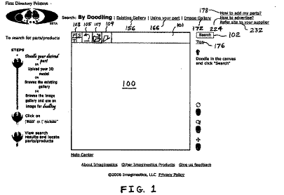

In general, the invention is directed to a method of creating a database of images of component parts and enabling a user to electronically doodle or draw a component part and search for the drawn component part in the database. FIG. 1 illustrates a page of one embodiment of a web site that may be used to implement the method of the present invention. The web page, which may appear on a user's monitor, includes a canvas 100 in which a user may doodle, sketch or draw a desired component, i.e., “part”, that he would like to find, locate, or obtain. The user may draw within canvas 100 by locating a cursor within canvas 100, holding down the left mouse button, and then moving the mouse in order to thereby draw lines that follow the movement of the mouse. Although a drawing tool in the form of a “mouse” is referred to herein, it is to be understood that it is equally possible for another type of drawing tool, such as a pen device, to be used in conjunction with the present invention. After the drawing is complete, the user may use the mouse to click on a search icon 102. In response to search icon 102 being clicked on, the server hosting the web site may search an electronic database of component images for a component image that most closely resembles or matches the image drawn by the user in canvas 100. The components in the database may be components that are commercially available through various vendors. When the matching component is found in the database, the image of the matching component may be displayed on the user's monitor along with the name of the vendor that supplies the part, a link to the vendor's web site, or to a particular page on the vendor's web site on which the matching part may be found, and other information that may be of interest to the user.

For the sake of brevity, the database may be referred to herein as storing images or image data. However, it is to be understood that the database may actually store the shape representations of three-dimensional models and two-dimensional drawings and related data, such as images for thumbnail displays and three-dimensional/two-dimensional light viewable files, e.g., i3D format, which is proprietary to Imaginestics, LLC. “Image data”, as used herein, may include not just an image expressed in ones and zeros, which is a static snapshot of an object, or a representation of a component model. Rather, “image data” may incorporate a component model, which may include a plurality of two-dimensional images from different viewpoints in three-dimensional space, i.e., a three-dimensional model, as well as names/descriptors of models/parts, part numbers, and other identification and sourcing information.

The searching of the database may be performed as disclosed in U.S. Patent Application Publication No. 2004/0249809, titled METHODS, SYSTEMS, AND DATA STRUCTURES FOR PERFORMING SEARCHES ON THREE DIMENSIONAL OBJECTS, published Dec. 9, 2004, which is expressly incorporated herein by reference.

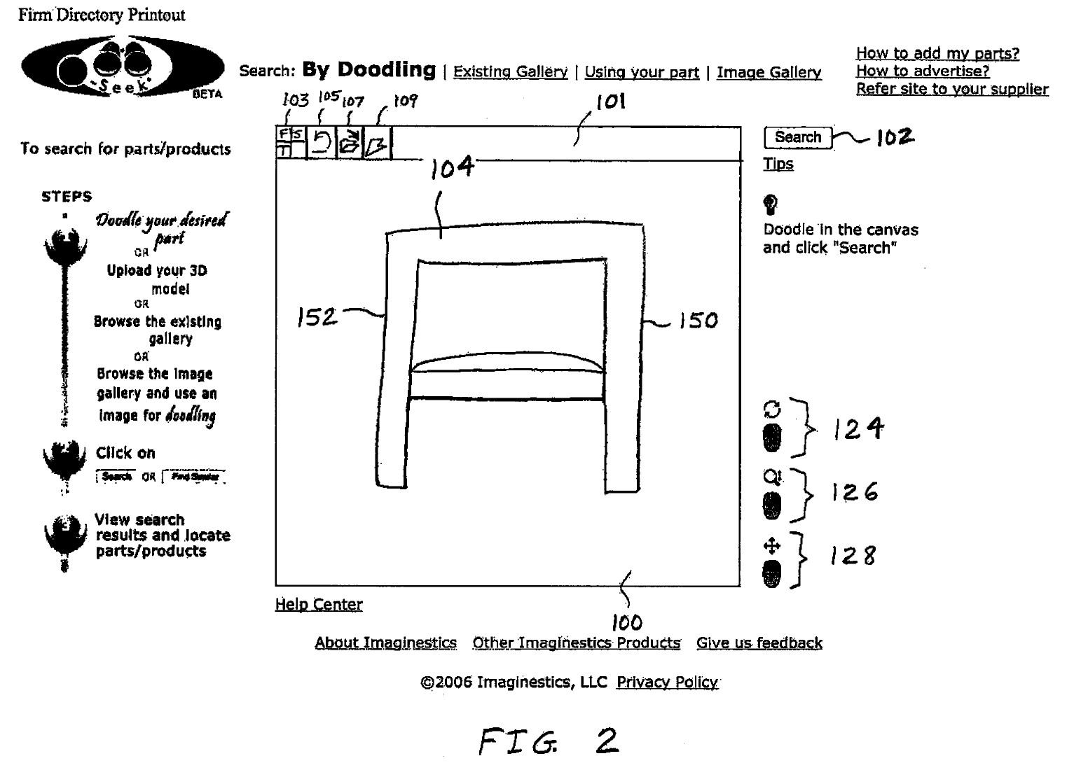

FIG. 2 illustrates a canvas 100 having a component part image in the form of a chair image 104 drawn therein by a user. In this example, the user sketched or doodled a front view of the desired chair. However, it is also possible for the user to draw a side, top, or any perspective view of the chair. It is not necessary for the user to designate what type of view that he has drawn, as the searching of the component images in the database may accommodate any type of view or viewing angle that the user may enter. Canvas 100 may include a toolbar 101 providing a Front, Side, Top Views icon 103, an Undo Stroke icon 105, an Open Background Image icon 107, and a Start Doodling icon 109. Clicking on Front, Side, Top Views icon 103 results in canvas 100 being divided into four quadrants, enabling the user to draw separate front, side and top views of the part to be searched for, with each of the three views being simultaneously considered by the search engine. Clicking on Undo Stroke icon 105 results in the last stroke doodled by the user being erased or deleted from canvas 100. Clicking on Open Background Image icon 107 enables the user to upload an image onto canvas 100. Clicking on Start Doodling icon 109 after a part found in a search has been displayed on canvas 100 enables the user to add doodling to the displayed search result component and thereby refine a search to be made subsequently.

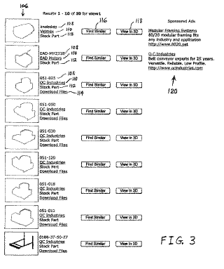

After the user has drawn chair image 104 and clicked on search icon 102, the server may respond with a web page having a format similar to that shown in FIG. 3. The web page may provide a list of search results including component images 106. Images 106 may be listed in order of how closely they match the doodled image for which the search was requested. Beside each image may be a descriptor or model number 108, a link 110 to the part vendor's web site, an indication 112 of whether the vendor keeps the part in stock or whether the part is manufactured upon request, and a link 114 enabling the user to download image files for the part.

The user may decide that one of the images 106 is close to the part that he is looking for, but he may like to look at other database images that are similar to the image 106. The user may then elect to click on a Find Similar icon 116 that may return a web page that is formatted similarly to FIG. 3, but that lists parts that are similar to the image 106 for which the Find Similar request was made. The user may then select one of the resulting images or obtain further information, just as he could from the original search results shown in FIG. 3.

If the user would like to view one of images 106 in three dimensions, then he may click on the image 106 itself, or he may click on a View in 3D icon 118. The web page of FIG. 3 may also include advertisements 120 provided by the vendors whose parts are shown in images 106 on the web page.

In one embodiment, the user's or “purchaser's” e-mail address is forwarded to the vendor in the event of the user indicating interest in a component associated with the vendor. The vendor may then e-mail to the user further or updated information about the component in which the user expressed interest, or about other components that are related to the component in which the user expressed interest. The user may express interest in a component by clicking on an image of the component, clicking on a link 110, 114 associated with the component, clicking on one of icons 116, 118, or clicking on a sponsored ad 120, for example.

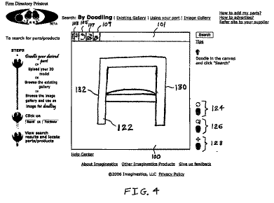

The three-dimensional image obtained by clicking on image 106 or by clicking on View in 3D icon 118 may be provided as a perspective view, e.g., an enlargement of image 106, or as an orthographic view, i.e., a front, side, or top view. However, the type of view may be of no consequence to the system, and there may be no designation of the type of view by either the system or the user. In one embodiment, the “three-dimensional image” is provided from the same viewpoint as the original image 104 was doodled from in canvas 100. Thus, the “three-dimensional image” provided by the system may appear very similar to, or substantially identical to, the original image 104, as is the image 122 of FIG. 4, which may be provided by the system in response to clicking on an image 106 or on View in 3D icon 118.

Although image 122 is provided by the system on a two-dimensional screen, the image is referred to herein as being three-dimensional in the sense that the user may use the mouse to turn or rotate image 122 such that the image may be transformed to present the component from any viewpoint desired by the user. More particularly, as indicated at 124 in FIG. 4, a user may hold down the left mouse button and move the mouse to thereby cause image 122 to rotate in selected directions. For example, if the user holds down the left mouse button and moves the mouse upward on canvas 100, it may cause image 122 to rotate about a horizontal axis such that the lower portion of image 122 rotates toward the viewer, and the upper portion of image 122 rotates away from the viewer. If the user holds down the left mouse button and moves the mouse downward on canvas 100, it may cause image 122 to rotate about the horizontal axis such that the lower portion of image 122 rotates away from the viewer, and the upper portion of image 122 rotates toward the viewer. If the user holds down the left mouse button and moves the mouse rightward on canvas 100, it may cause image 122 to rotate about a vertical axis such that the right-hand end of image 122 rotates toward the viewer, and the left-hand end of image 122 rotates away from the viewer. If the user holds down the left mouse button and moves the mouse leftward on canvas 100, it may cause image 122 to rotate about the vertical axis such that the left-hand end of image 122 rotates toward the viewer, and the right-hand end of image 122 rotates away from the viewer. The user may combine directions of movement to cause image 122 to rotate about differently oriented axes. That is, the direction of mouse movement may include both vertical and lateral components to thereby cause image 122 to rotate about a skewed axis.

It is possible for an angular distance that the image has been rotated from an initial reference position to be displayed on the web page so that the user may rotate the image a particular desired distance, such as ninety degrees, for example. The distance of rotation may be expressed in degrees relative to each of three perpendicular axes.

As indicated at 126, the user may magnify image 122, or zoom in and out relative to image 122, by holding down the right mouse button and moving the mouse upward in order to zoom in or downward in order to zoom out. As indicated at 128, the user may shift image 122 upward, downward, rightward, leftward, or in a direction having both vertical and lateral components, by holding down both the left and right mouse buttons and moving the mouse in the desired direction.

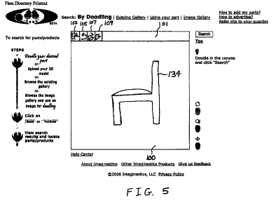

After the user has examined the search result image 122 of FIG. 4, he may want to look at the part represented by image 122 from another angle in order to better determine the level of similarity between the part he is seeking and the part represented by image 122. In order to view the part from another angle, the user may hold down the left mouse button, as indicated at 124, and rotate image 122 as desired. For example, the user may hold down the left mouse button and move the mouse rightward to thereby rotate image 122 about a vertical axis such that a right-hand edge 130 of image 122 rotates toward the user and a left-hand edge 132 of image 122 rotates away from the user. The user may watch the image rotate, in what appears to be a continuous rotation, as he moves the mouse rightward. After ninety degrees of such rotation about a vertical axis, the image on canvas 100 may appear similar to image 134 shown in FIG. 5. Because the search result images displayed on canvas 100 may be viewed from different angles, they are referred to herein as “three-dimensional images”.

It is to be understood that images 122, 134, as well as all of the intermediate images appearing on canvas 100, may be created by a three-dimensional software rasterization engine within the server that runs the web site. The rasterization engine may create the images based upon image data that is stored in the database within the server.

If image 134 does not suitably match, i.e., substantially differs from, the component that the user is seeking, then the user may click on Start Doodling icon 109 and then doodle on image 134 to thereby improve the resemblance between image 134 and the part being sought. After the image 134 has been thus revised via doodling, then the user may again initiate a search by clicking on Search icon 102. Because the input image is three-dimensional and generally more representative of the part being sought after the user has revised image 134, the search engine may return search results that are more similar to, or a better match for, the part being sought by the user. In addition to doodling, it is also possible that the user may erase portions of image 134 in order revise the input image corresponding to that particular view.

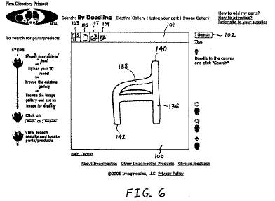

FIG. 6 illustrates an example of an input image 136 that may be created by a user doodling upon or otherwise revising image 134. In this particular example, the user may doodle in an arm rest 138 that may have not been visible in the doodled input image 104, and thus may have not been considered by the search engine in retrieving image 122 from the database.

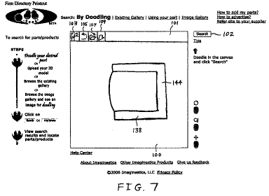

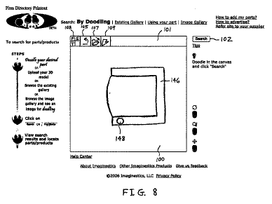

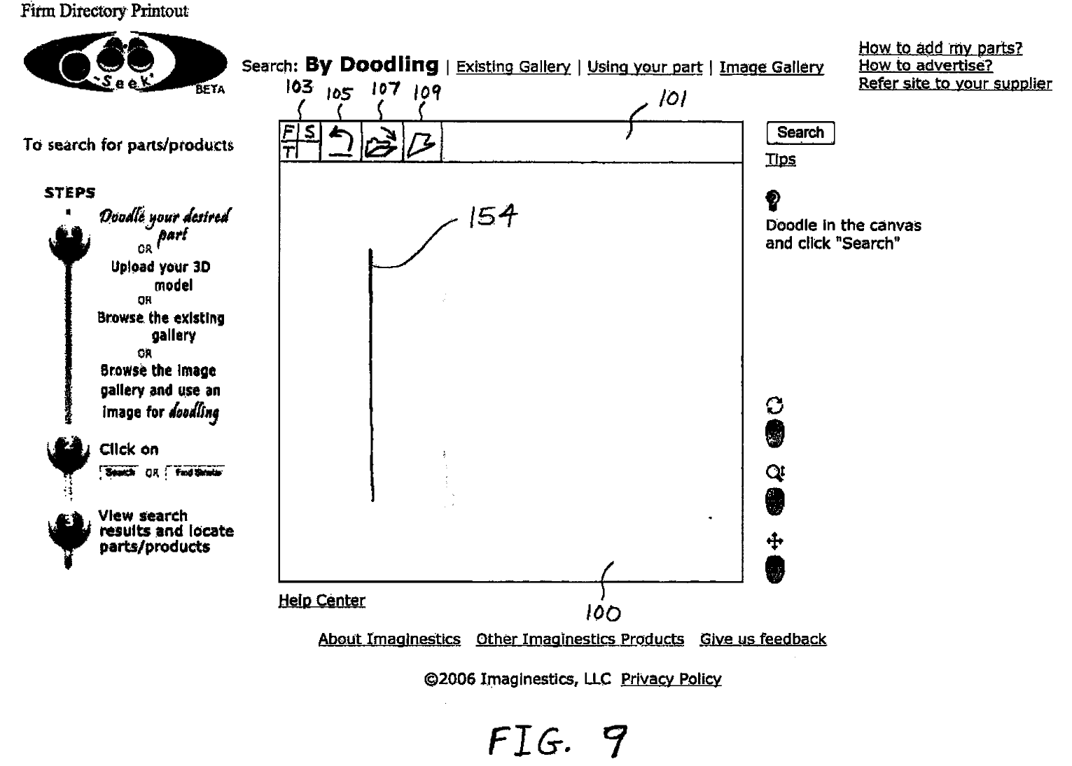

After the user has doodled to create image 136 of FIG. 6, he may want to look at and refine the input image from a third angle in order to better define the three-dimensional input image for which the search engine will seek a match in the database. The third angle may be displaced ninety degrees from each of the first two angles or viewpoints. In order to view the input image from the third angle or viewpoint, the user may hold down the left mouse button, as indicated at 124, and rotate image 136 of FIG. 6 as desired. For example, the user may hold down the left mouse button and move the mouse downward to thereby rotate image 136 about a horizontal axis such that an upper edge 140 of image 136 rotates toward the user and a lower edge 142 of image 136 rotates away from the user. The user may watch the image rotate, in what appears to be a continuous rotation, as he moves the mouse downward. After ninety degrees of such rotation about a horizontal axis, the image on canvas 100 may appear similar to image 144 shown in FIG. 7.

It is to be understood that, like images 122, 134, image 144, as well as all of the intermediate images appearing on canvas 100 during the rotation between image 134 and image 144, may be created by a three-dimensional software rasterization engine within the server that runs the web site. The rasterization engine may create the images based upon image data that is stored in the database within the server.

If image 144 does not match, i.e., differs from, the component that the user is seeking, then the user may click on Start Doodling icon 109 and then doodle on image 144 to thereby improve the resemblance between image 144 and the part being sought. After the image 144 has been thus revised via doodling, then the user may again initiate a search by clicking on Search icon 102. Because the input image is three-dimensional and generally more representative of the desired part after the user has revised images 134 and 144, the search engine may return search results that are more similar to, or a better match for, the part being sought by the user. In addition to doodling, it is also possible that the user may erase portions of image 144 in order revise the input image corresponding to that particular view.

FIG. 8 illustrates an example of an input image 146 that may be created by a user doodling upon or otherwise revising image 144. In this particular example, the user may doodle onto image 144 a cup holder 148 that may have not been visible in either of doodled input images 104 and 136. After the user has created at-least-partially-doodled images 104, 136, 146, he may click on Search icon 102 to thereby initiate a search based upon all three images 104, 136, 146. Thus, the present invention enables a user to provide a three-dimensional input image of a component via a two-dimensional medium, i.e., a screen or monitor, to serve as the subject of a database search for a similar or matching component, wherein a three-dimensional image of the similar or matching component is stored in the database.

It is also possible for the user to further refine the three-dimensional input image beyond the features or details shown in the three orthographic images. More particularly, in addition to, or instead of, any or all of the three orthographic images, the user may use the mouse as indicated at 124 to orient a doodled image, uploaded image, or partially doodled and partially uploaded image in any way desired. The user may add doodlings to the images in any viewpoint or orientation. There may be no limit to the number of doodled image viewpoints that may be entered into and considered by the search engine in finding a similar or matching component in the database.

The images shown in FIGS. 2-8 do not show any internal features or internal details of the depicted component. However, it is possible, in another embodiment, for either or both the doodled images or the images returned as search results to include internal features that would not be visible to the naked human eye from the particular viewpoint. That is, either or both the doodled images or the search result images may be presented as though the viewer had “X-ray vision”. Further, if included in the doodled images, such internal features may be considered by the search engine in conducting the search for a matching part in the database. In one embodiment, the user may indicate internal or obscured features by doodling them in dashed, dotted, or “phantom” lines. Similarly, the internal features of search result components may be indicated in dashed, dotted, or “phantom” lines.

In the embodiment discussed above, the user initiated a revised search by clicking on Search icon 102 only after both doodling to create image 136 from a second viewpoint and doodling to create image 146 from a third viewpoint, wherein the resulting search considered each of images 104, 136 and 146. Alternatively, the user may initiate a search immediately after creating the doodled image 136 of FIG. 6. After selecting a database component image matched thereto by the search engine, the user may rotate the database image ninety degrees and then doodle or draw a cup holder or some other revision on the database image. The user may then finally click on Search icon 102 to initiate a search based upon image 104, image 136, and the image created by the user doodling upon the search results that were based on image 136.

Thus, in the embodiments discussed above, the search may be conducted based upon three input images that may be associated with respective viewpoints that are orthogonal relative to each other. Moreover, each of the three input images may be at least partially created by the user by doodling. It is to be understood that it is possible within the scope of the invention for the search to be conducted based upon one image, two images, or more than three images. Further, if the search is based upon two or more images, there is no requirement that any of the images be associated with viewpoints that are orthogonal to one another.

In an alternative embodiment, instead of requesting a search immediately after doodling image 104 of FIG. 2, the user may doodle the part from at least one other angle to thereby provide more information on which to base the search. For example, after doodling image 104, the user may hold down the left mouse button as indicated at 124 and move the mouse rightward to thereby cause right-hand edge 150 of image 104 to rotate toward the viewer and left-hand edge 152 to rotate away from the viewer about a vertical axis. Because image 104 by itself may include no depth information in a direction perpendicular to the page of FIG. 2, the rasterization engine may treat the part represented by image 104 as a two-dimensional object. Thus, after ninety degrees of rotation about a vertical axis, an image 154 (FIG. 9) in the form of a vertically oriented line segment may appear on canvas 100. The user may then click on Start Doodling icon 109 and doodle an image similar to image 136 of FIG. 6. It is possible that some erasing or other transformation of image 154 may be performed by the user in order to create an image similar to image 136. At this point, the user is in the same situation as a user who has created image 136 in a previous embodiment. That is, the user may request a search, rotate the search result image and modify it, and then request another search based upon the modified search result image. Alternatively, instead of immediately initiating a search, the user may rotate the image one or more times to add more features before initiating a search.

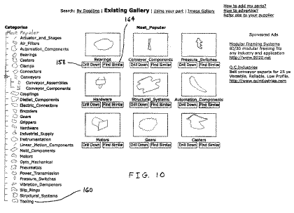

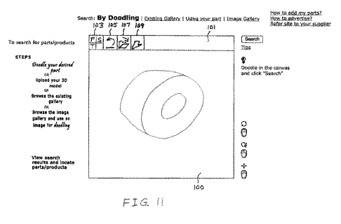

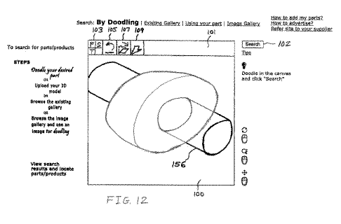

Instead of beginning the process of searching for a desired part on an empty canvas 100, the user may click on an Existing Gallery link 156 (FIG. 1) in order to be taken to a web page such as that shown in FIG. 10. The user may select one of the images in order to place that selected image on canvas 100. As shown in FIG. 10, each image may represent a respective category of part that has been frequently selected by other users. For example, the user may click on the image of the bearing at the upper left of FIG. 10 in order to have the image transferred to canvas 100, as shown in FIG. 11. The user may then click on Start Doodling icon 109 and start doodling revisions onto the image in canvas 100 of FIG. 11. For example, the user may doodle a shaft 156 (FIG. 12) extending through the bearing. The user may then click on Search icon 102 in order to initiate a search of the database. Alternatively, the user may rotate the bearing image, before or afterdoodling shaft 156, and doodle other features that are to be sought in a subsequent search of the parts database. The various possible search procedures may be substantially similar to those discussed above in other embodiments.

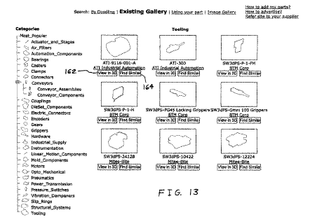

Alternatively, when presented with the web page of FIG. 10, the user may, instead of clicking on an image, click on one of the categories on the left-hand side of the page, or may click on a Drill Down icon 158 corresponding to that category to thereby achieve the same result. For example, a user may click on a Tooling category link 160, in order to be taken to web page such as FIG. 13 in which a plurality of images of parts that are in the Tooling category are presented. The user may either click on an image that interests him or click on a View in 3D icon 162 in order to place the image on canvas 100, as shown in FIG. 11. The user may then doodle revisions and/or initiate searches as described above and as he sees fit. In either the web page of FIG. 10 or the web page of FIG. 13, the user may click on a Find Similar icon 164 in order to be taken to a web page (not shown) including images of parts similar to the part associated with the particular Find Similar icon 164 that was clicked upon.

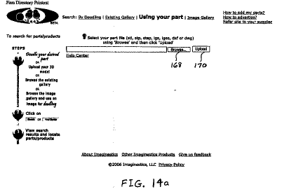

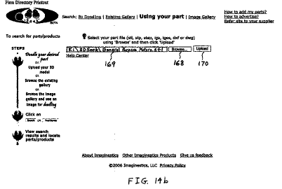

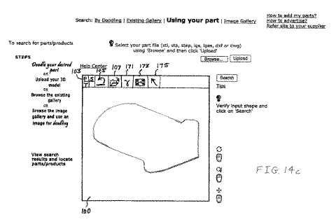

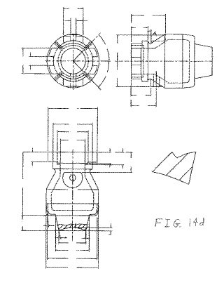

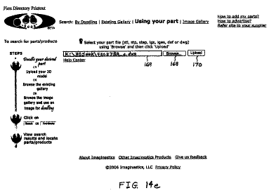

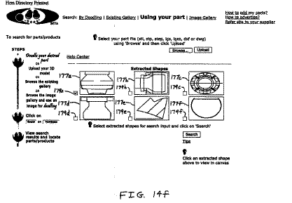

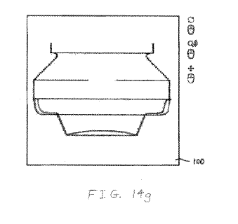

Instead of beginning the process of searching for a desired part on an empty canvas 100, or by clicking on Existing Gallery link 156, the user may click on a Using Your Part link 166 (FIG. 1) in order to be taken to a web page such as that shown in FIG. 14a. By clicking on Browse icon 168, the user may locate a stored file including image data of a part for which he would like to search. The file may be stored on the user's computer, or somewhere on a network that the user's computer may be connected to. As indicated in FIG. 14a, the user may upload files of type stl, stp, step, igs, iges, dxf, dwg, jpg or png. Of course these files types are given merely as examples, and it is possible for other types of files to be uploaded. FIG. 14b shows a stl file path that has been entered into field 169 via browsing. After the image file has been located, the user may click on Upload icon 170 to thereby upload the selected image file onto canvas 100, as shown in the web page of FIG. 14c. The user may then doodle revisions on the uploaded image after clicking on a Start Doodling icon 171. The user may also click on Fit View icon 173 to cause the image to fit canvas 100. If the user would like to use the mouse to rotate the image instead of doodling, he may click on a Mouse Zoom, Rotate or Pan icon 175. When the user is done modifying the image, he may initiate searches as described above and as the user finds appropriate.

FIG. 14c is an example illustrating that, as mentioned above, the input image data entered onto canvas 100 may be in the form of a perspective view, rather than an orthographic view. Of course, it is also possible for a user to upload orthographic views onto canvas 100. Although the perspective view image in FIG. 14c has been uploaded by a user, it is to be understood that it is also possible within the scope of the invention for a perspective view to be entered onto canvas 100 by doodling and/or by being retrieved from the database. Regardless of how the perspective view is entered onto canvas 100, the user may iteratively rotate the image and doodle in modifications as described herein before requesting a search.

FIG. 14d shows a dwg file that may be uploaded to the web site. FIG. 14e shows a dwg file path that has been entered into field 169 via browsing. After the image file has been located, the user may click on Upload icon 170 to thereby upload the selected image file onto canvas 100, as shown in the web page of FIGS. 14f-g. Several different extracted shapes 177a-f of the dwg file may be selected by the user for display within canvas 100. That is, FIG. 14f shows extracted shape 177a displayed within canvas 100, but any of the other extracted shapes 177b-f may also be displayed within canvas 100 by the user clicking on the extracted shape. The user may click on any combination of boxes 179a-f in order to include the associated extracted shapes in the search input image data. That is, the user may select any one, two, three, four, five or six of the extracted shapes to be used as input for the search. In one embodiment, the database does not include cross-sectional image information, and thus, in order to obtain good search results, the user may not want to include in the search input data any extracted shapes that were in the form of cross-sectional views.

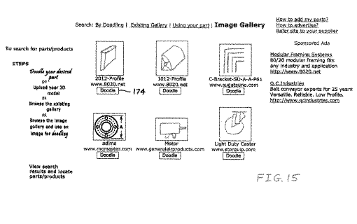

Another option at the starting point of FIG. 1 is for the user to click on Image Gallery link 172, which takes the user to the web page shown in FIG. 15. This Image Gallery option may introduce the user to the concept of doodling on an existing image in order to search the database for a part incorporating both the image provided by the computer system and the doodled revisions to the image which are provided by the user. In the web page of FIG. 15, the user may click on either one of the provided images or a Doodle icon 174 associated with the image. The selected image is then provided on a canvas 100, similarly to what is shown in FIG. 4. The user may then doodle upon the image, rotate the image, and/or search for the image in the database as discussed in detail above.

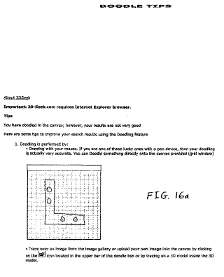

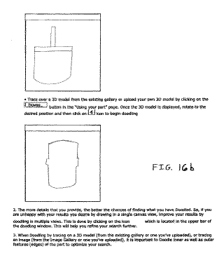

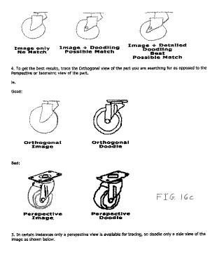

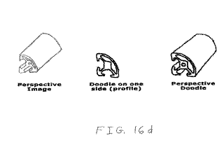

In addition to Image Gallery link 172, another tool that may be provided to familiarize the user with the Search By Doodling concept is the Tips link 176 (FIG. 1) that may be located adjacent to each canvas 100. Upon clicking on Tips link 176, the user may be taken to the web page of FIGS. 16a-d, which includes tips and advice to the user on what doodling techniques he should use in order to obtain better search results. As FIGS. 16a-d make clear, it is possible for a user's doodlings to be in the form of tracing important features of an uploaded or retrieved image. Further, it is possible to conduct a search based exclusively on such traced doodlings without regard to the underlying uploaded or retrieved image.

Discussed above are novel methods of enabling a user to create a detailed three-dimensional input image for use in searching a component image database. Other novel features of the present invention are directed to methods of providing an electronic commercial showplace for component parts. Vendors of parts or products may upload their image data or model data to the database, wherein the image data or model data corresponds to component parts that are associated with the vendors. Parts that are “associated with the vendors” may include parts sold by the vendors, parts included in a vendor's products, parts that the vendor is capable of producing, or parts that are representative of the vendor's design or manufacturing capabilities, for example. Novel features of the present invention may include compiling image data to thereby form the component image database that is searched. Users of the web site may include commercial suppliers of components who would like information regarding their wares to be included in the database. The part information accessible on the database may include image data, part size, part color, purchase prices, links to the supplier's web site, model numbers, whether the part is a part stock, whether the part is in stock, etc.

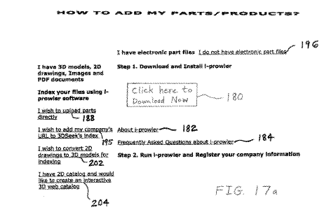

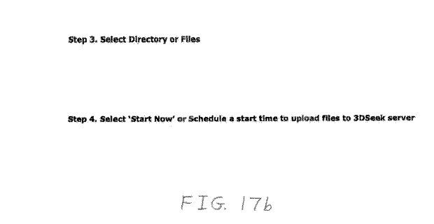

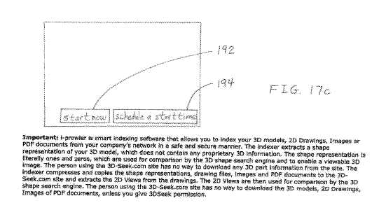

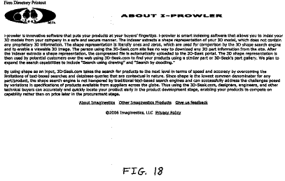

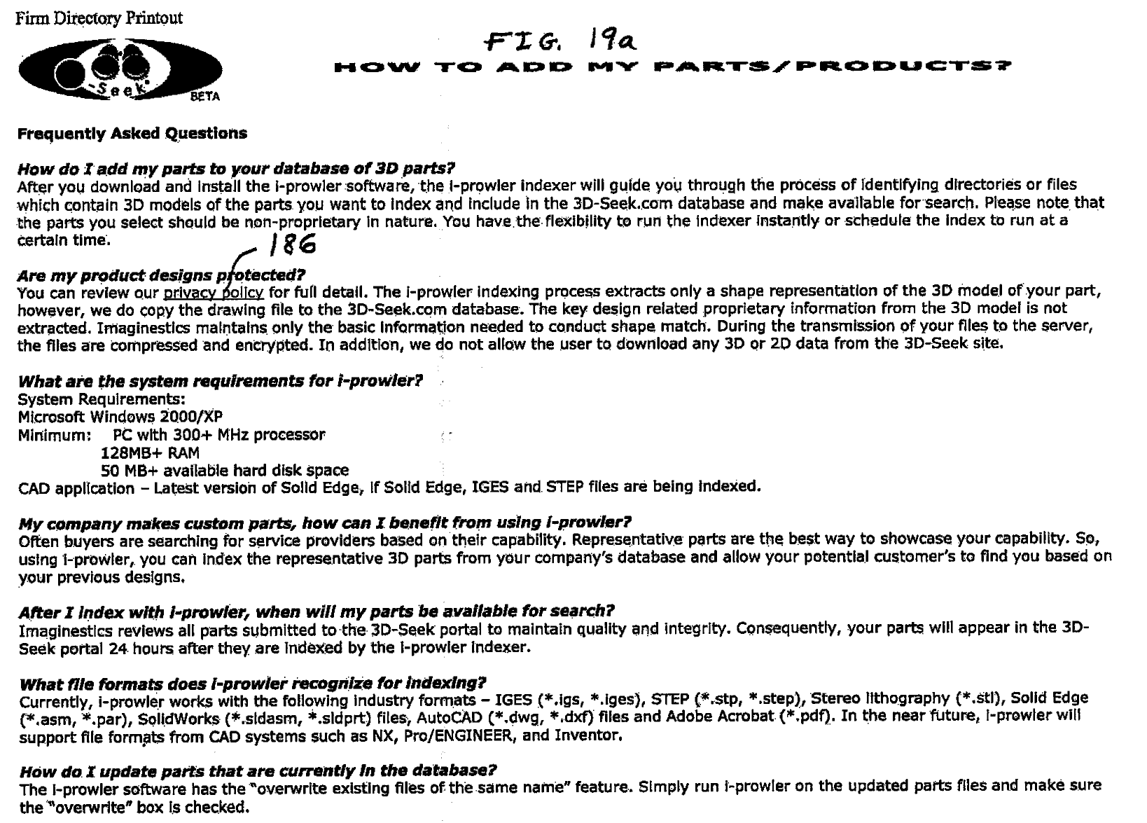

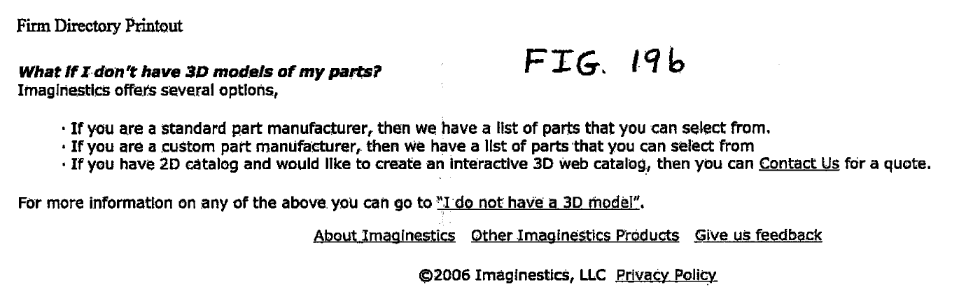

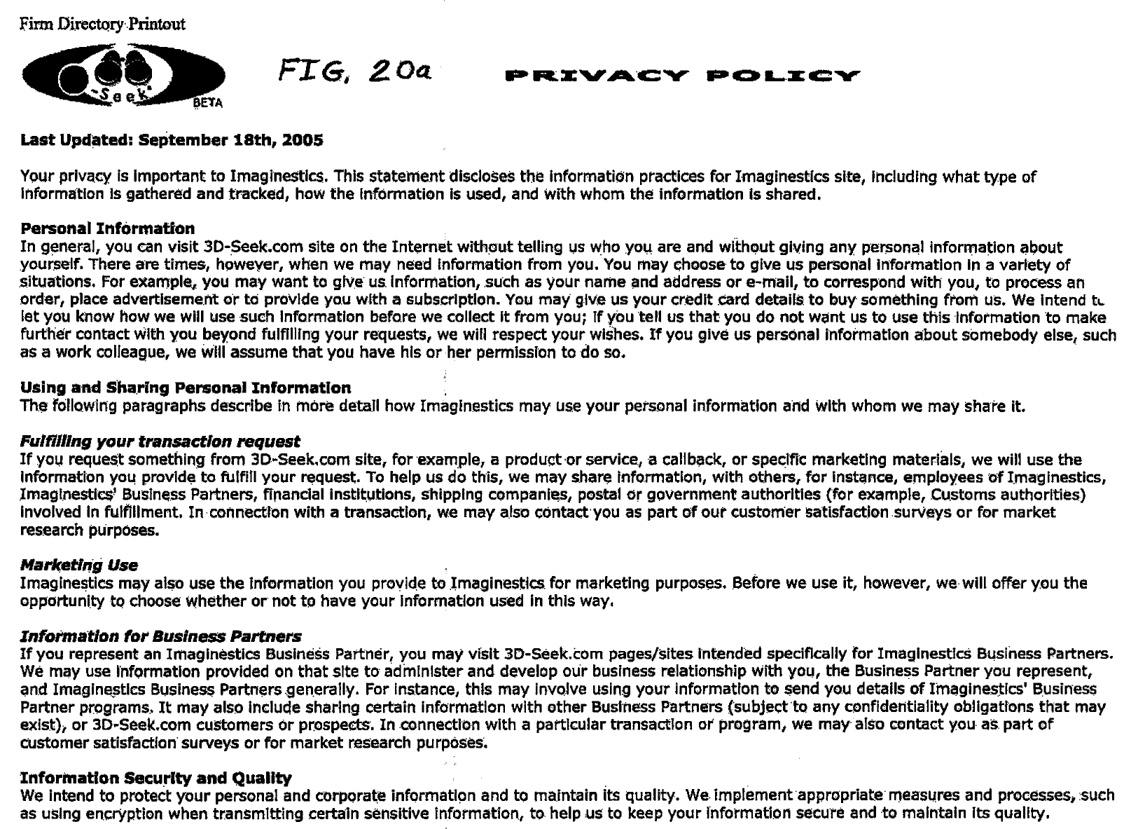

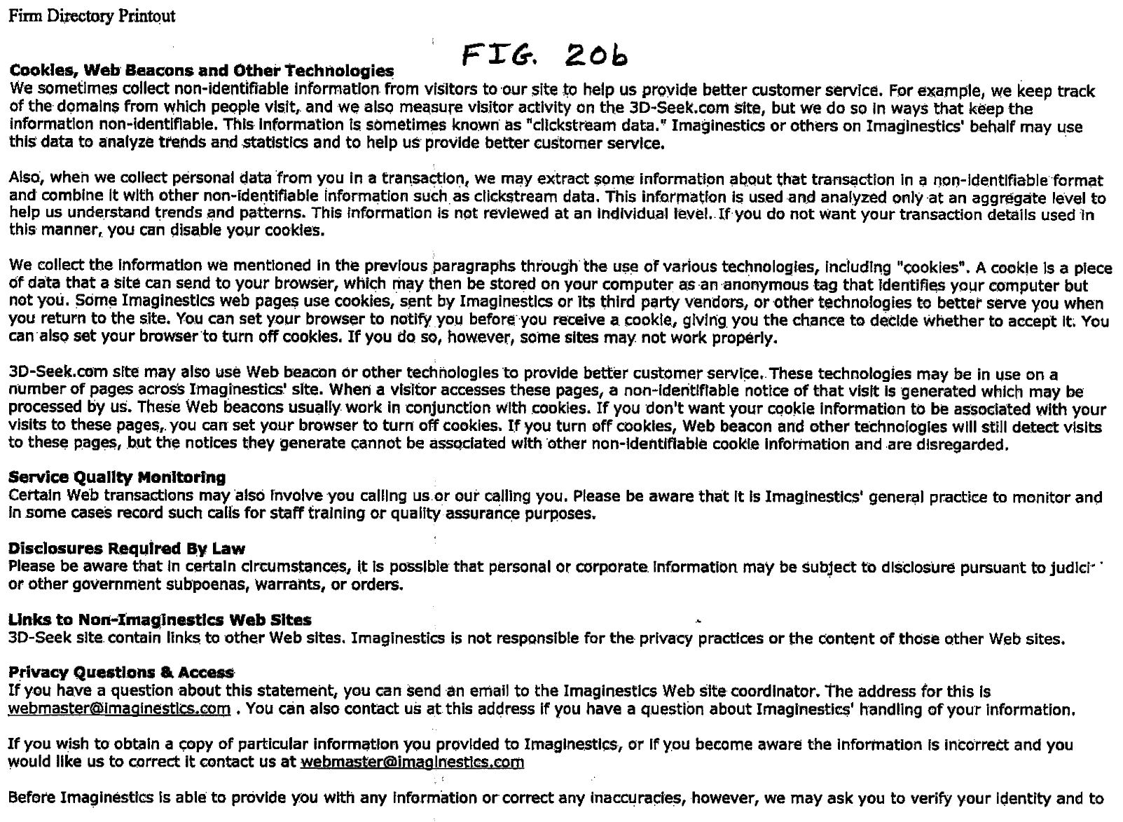

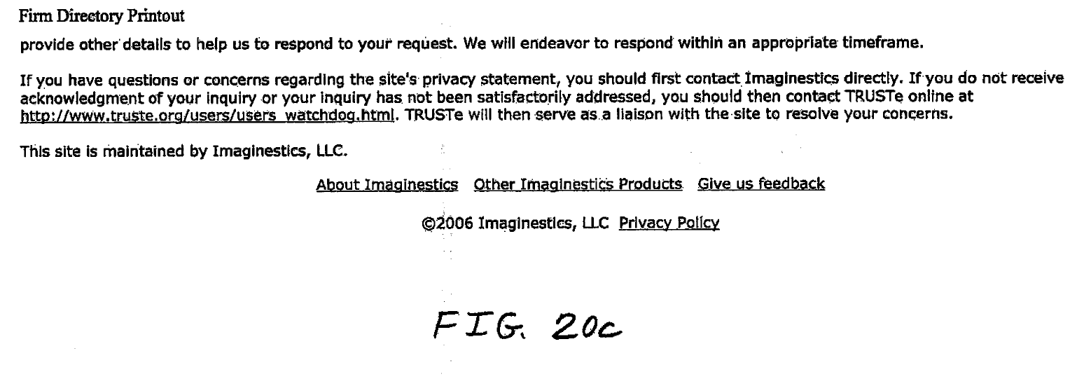

A user who is a part supplier may click on a How to add my parts? link 178 on the web page of FIG. 1, and may then be taken to the web page of FIGS. 17a-c. In a first step, a supplier that has electronic part files such as three-dimensional models, two-dimensional drawings, images, and pdf documents of components stored on its web site may click on icon 180 in order to download i-prowler software. The i-prowler software may enable the supplier to transfer the electronic part files from his web site to the database of the host web site so that the electronic part files may be included in searches conducted on the host web site. Before downloading the i-prowler software, the supplier may obtain more information about i-prowler by clicking on an About i-prowler link 182, which takes the supplier to the web page of FIG. 18. By clicking on a “Frequently Asked Questions about i-prowler” link 184, the supplier may be taken to the web page of FIGS. 19a-b, which lists questions that may be frequently asked and their respective answers. If the supplier clicks on a privacy policy link 186 in FIG. 19a, he is taken to the web page of FIGS. 20a-c.

After downloading the i-prowler software from the host web site, the supplier may run i-prowler, register his company information, and select a directory or files to index, as directed in FIGS. 17a-b. The supplier may then be directed to select a Start Now icon 192 (FIG. 17c) to immediately upload image files to the host 3DSeek server, or to select a Schedule a start time icon 194 to schedule a start time to upload image files to the host 3DSeek server.

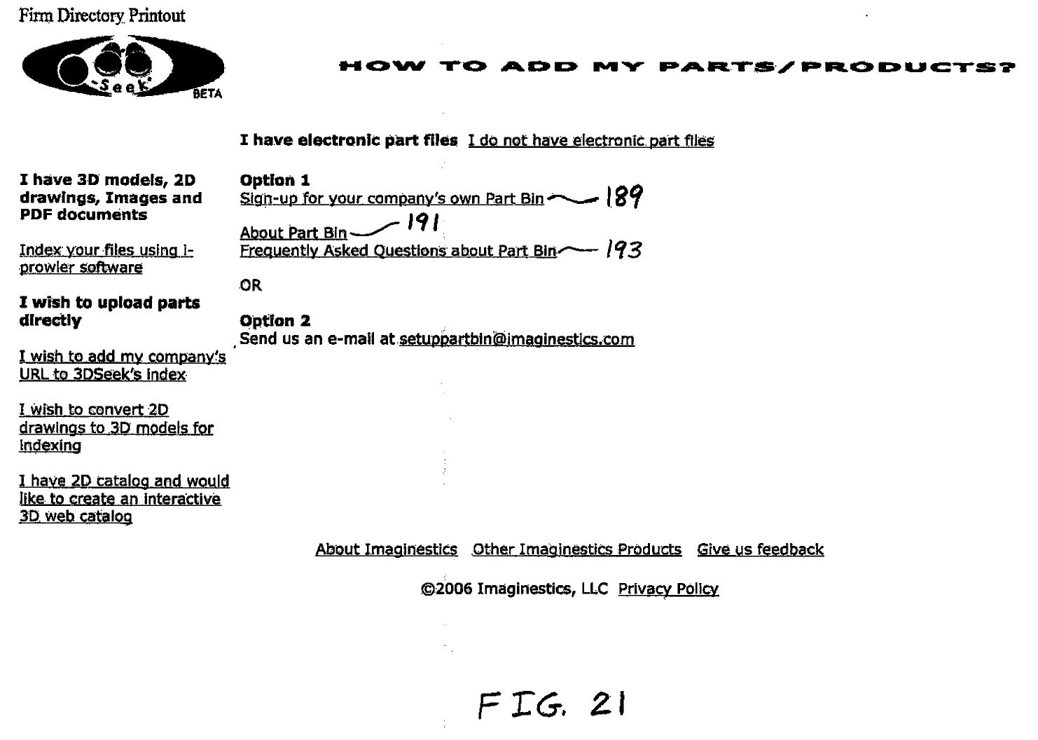

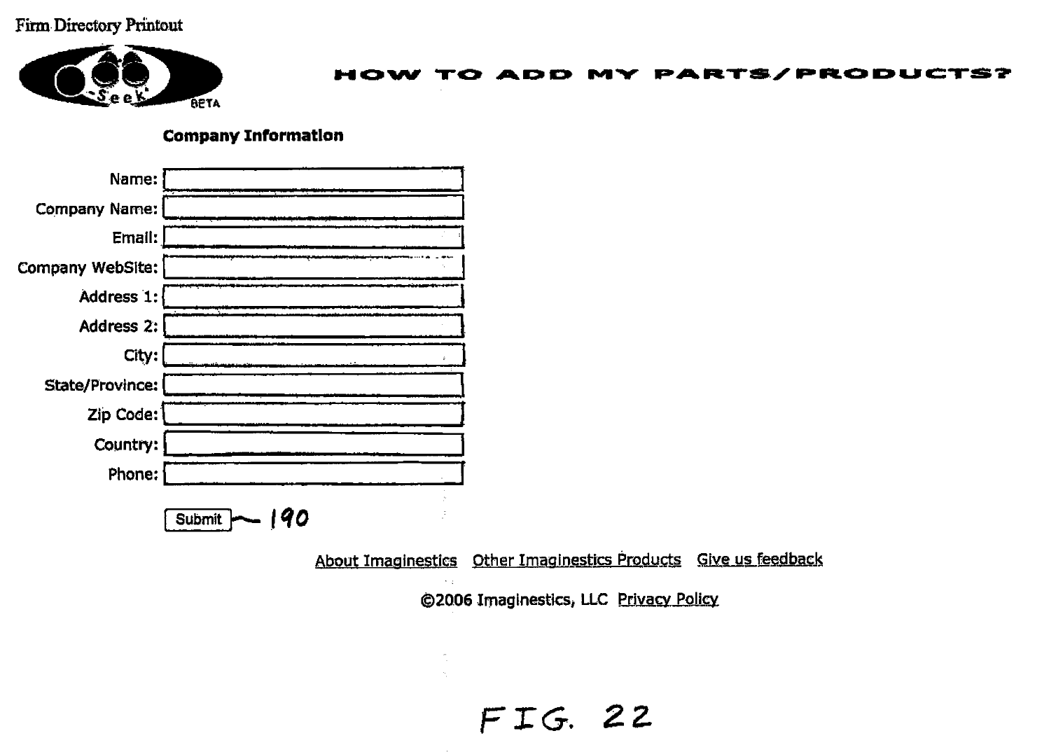

The user may click on an “I wish to upload parts directly” link 188 (FIG. 17a) to be taken to the web page of FIG. 21. Under “Option 1”, the supplier may click on a “Sign-up for your company's own Part Bin” link 189 to be taken to the web page of FIG. 22, wherein the supplier may fill in his company's information and click on a Submit icon 190 to complete the registration.

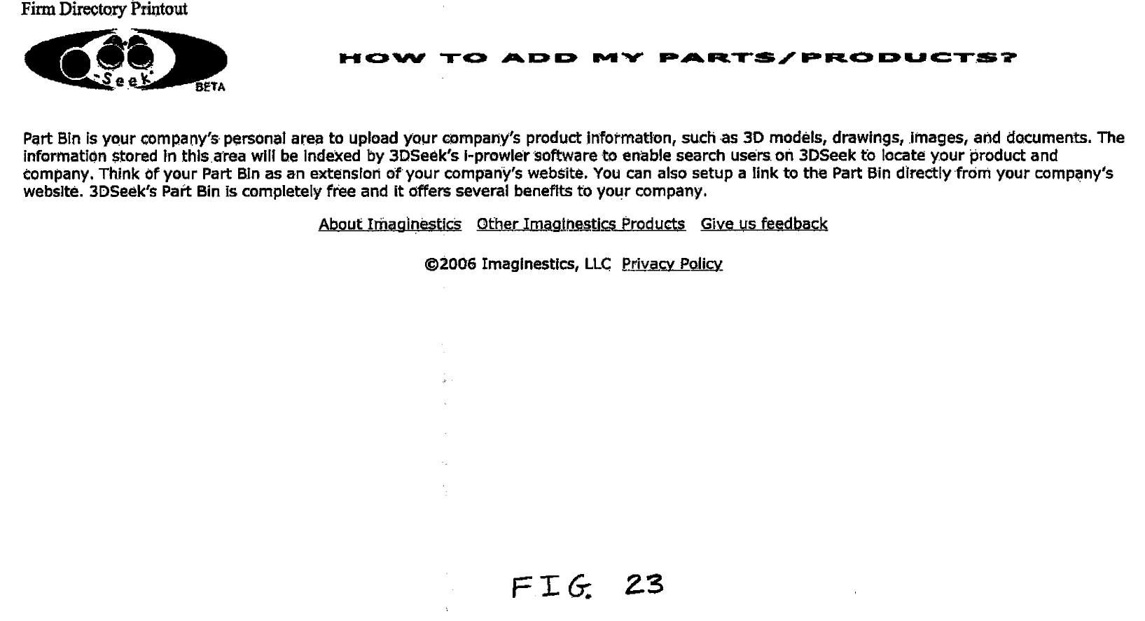

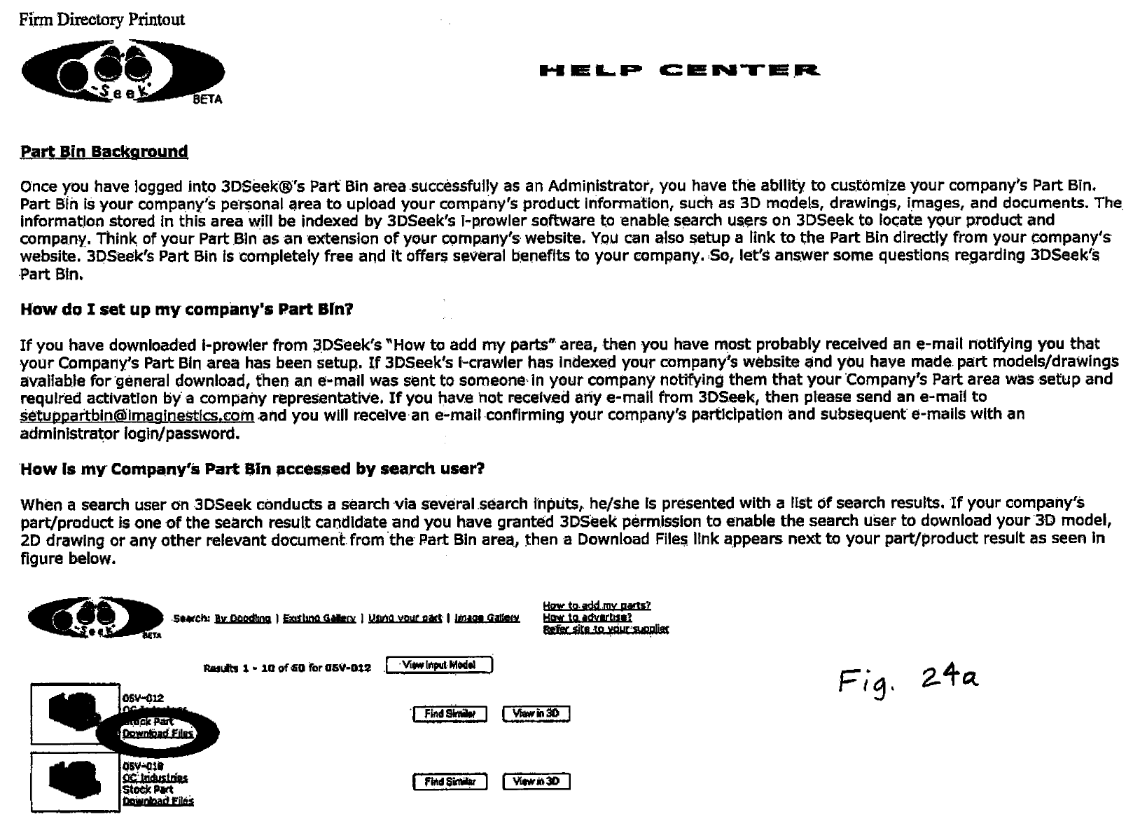

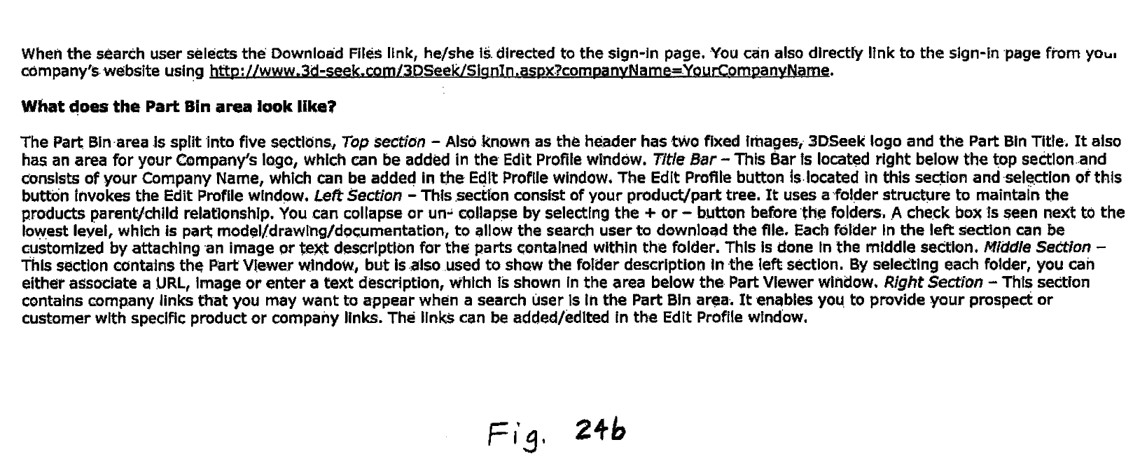

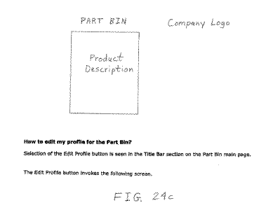

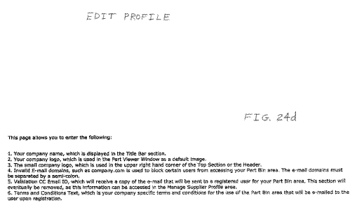

The user may click on an “About Part Bin” link 191 (FIG. 21) to be taken to the web page of FIG. 23 wherein an explanation of Part Bin is provided. The user may also click on a “Frequently Asked Questions about Part Bin” link 193 (FIG. 21) to be taken to the web page of FIGS. 24a-e wherein questions about Part Bin that may be frequently asked and the associated answers are provided.

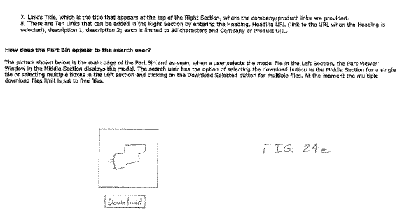

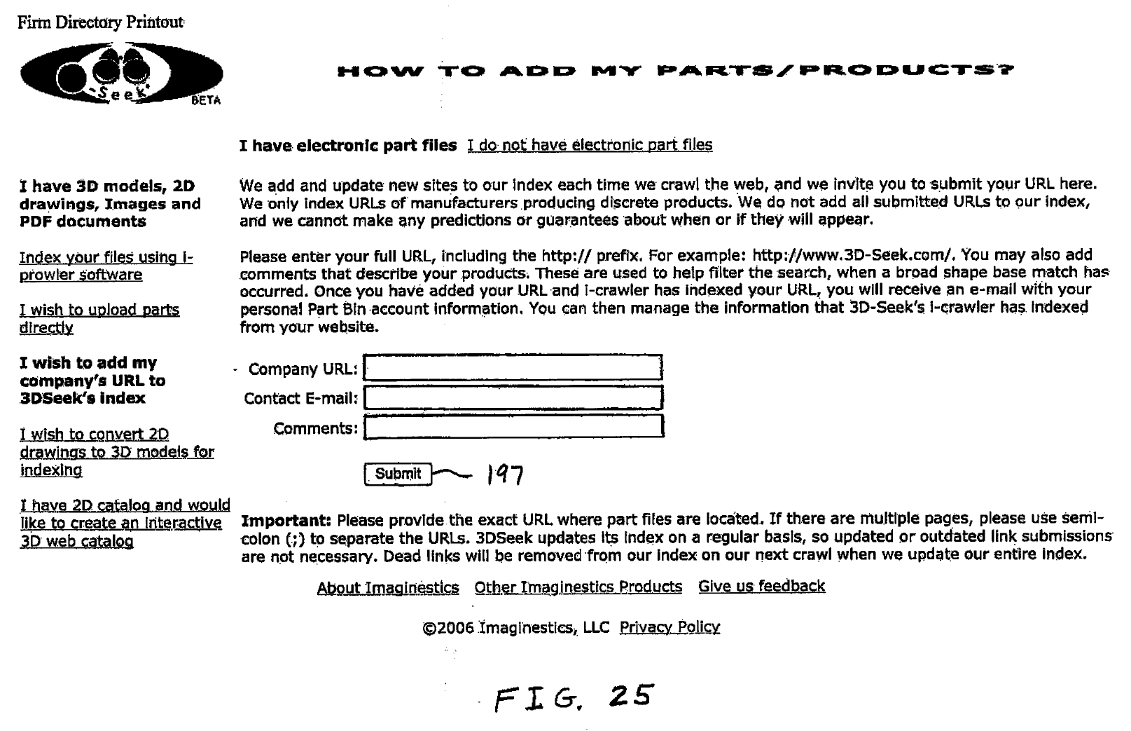

At the web page of FIG. 17a, the user may click on an “I wish to add my company's URL to 3DSeek's index” link 195 to be taken to the web page of FIG. 25 wherein, after filling in the URL, email address and comments, the supplier may click on a Submit icon 197 in order to complete the registration of his company's URL. Receiving such URL registrations enables the server to proactively gather component part information from suppliers' web sites without requiring the suppliers to actively submit their component part information. Thus, an index of part vendor web sites may be compiled wherein the part vendors have granted permission to extract image data and other component part information from the web sites. The server may then extract the image data from the vendor web sites, and store the gathered component part information in the database, where it may be searched by purchasers seeking a part with particular characteristics. The image data may be uploaded to the database via a host web site, wherein the uploaded image data is associated with component parts that are sold by the vendors. A purchaser may than enter image data onto the host web site, wherein the image data represents a component that the purchaser would like to buy. The purchaser may request a search of the database for vendor image data matching the purchaser image data. A matching vendor image and vendor information may be displayed to the purchaser on the host web site, wherein the vendor information is associated with the matching vendor image data.

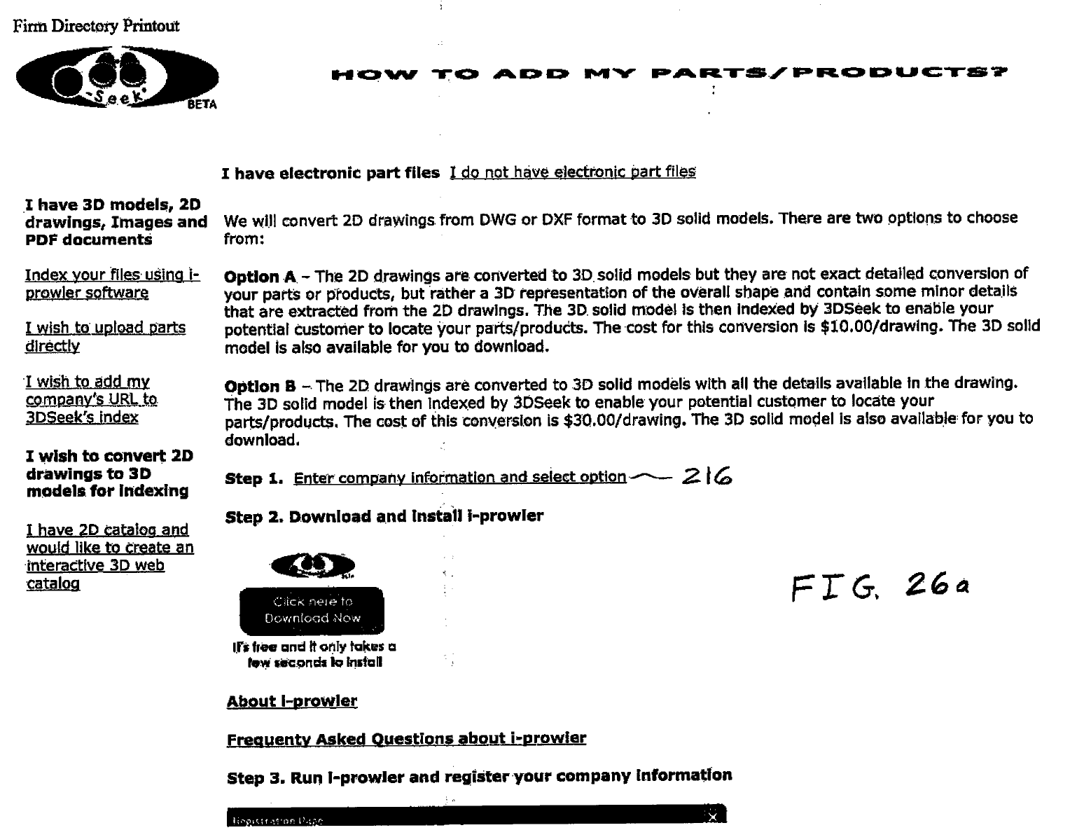

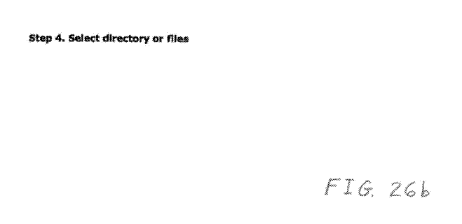

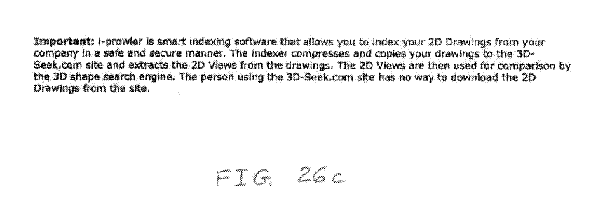

The user may click on an “I wish to convert 2D drawings to 3D models for indexing” link 202 (FIG. 17a) to be taken to the web page of FIGS. 26a-c. The supplier may then click on the “Enter company information and select option” link 216 to thereby be taken to the web page of FIG. 27. After filling in the company information fields in FIG. 27 and selecting Option A or Option B, the supplier may click on a Submit icon 218 to thereby complete the registration.

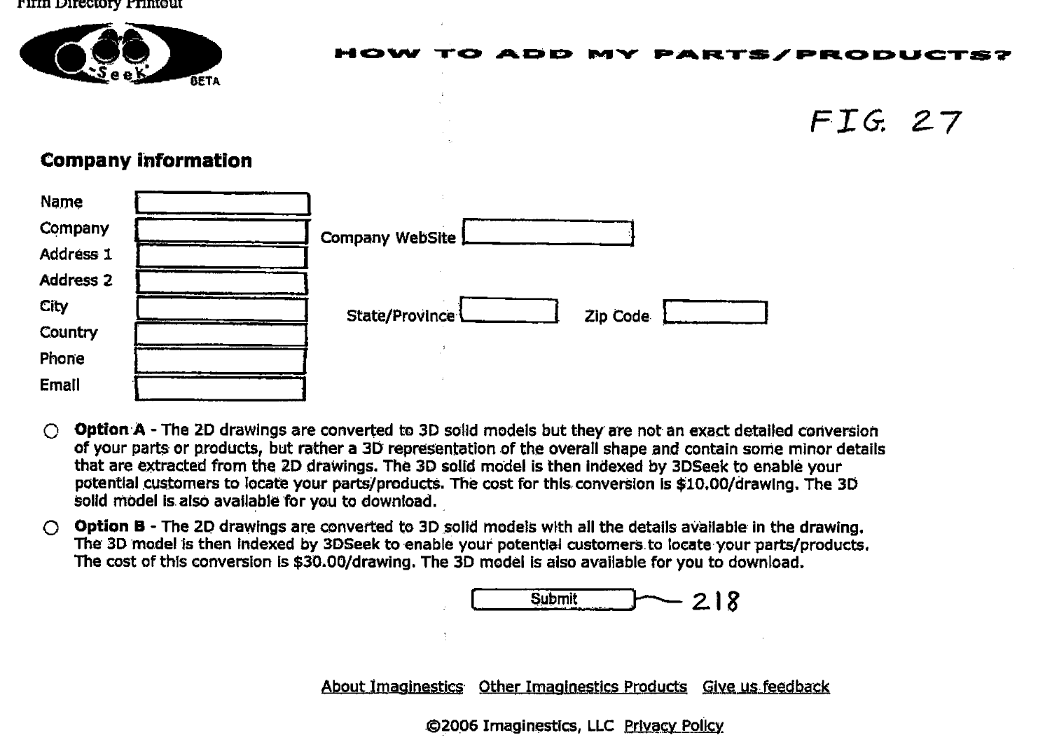

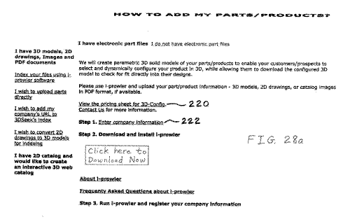

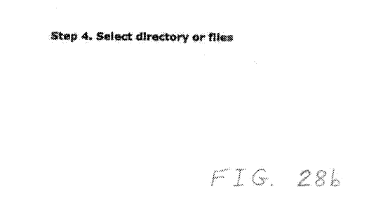

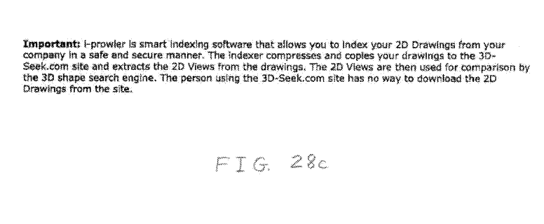

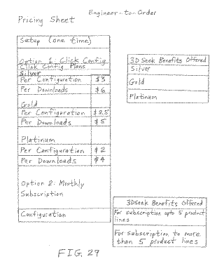

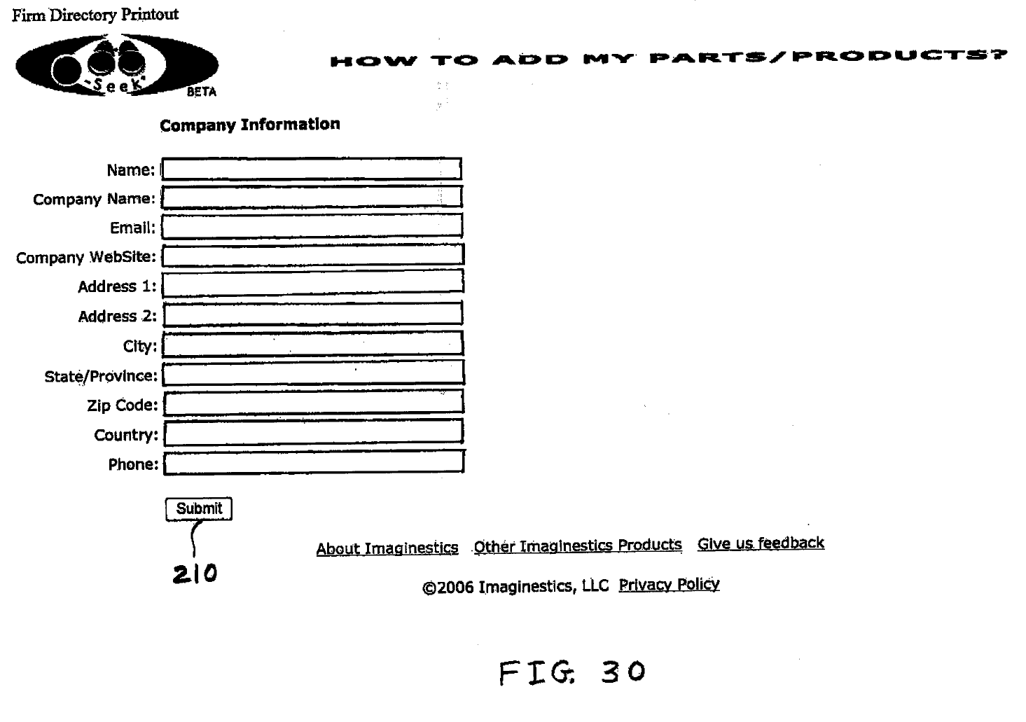

If the supplier clicks on link 204 in FIG. 17a, he may be taken to the web page of FIGS. 28a-c. The supplier may then click on the View the pricing sheet for 3D-Config. link 220 (FIG. 28a) to thereby be taken to the web page of FIG. 29, which may be a pdf file containing pricing and other information. The supplier may also click on the “Enter company information” link 222 (FIG. 28a) to thereby be taken to the web page of FIG. 30. After filling in the fields in FIG. 30, the supplier may click on a Submit icon 210 to thereby complete the registration. The user may then download and install i-prowler (Step 2; FIG. 28a), run i-prowler and register his company information (Step 3), and Select directory or files (Step 4; FIG. 28b).

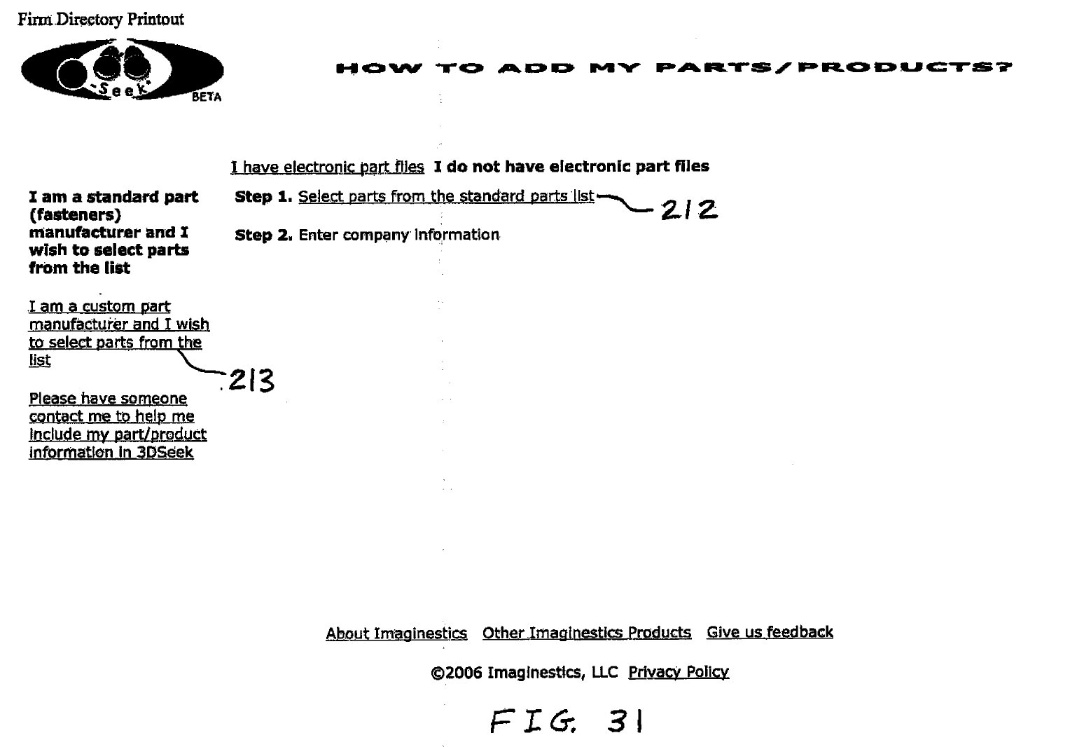

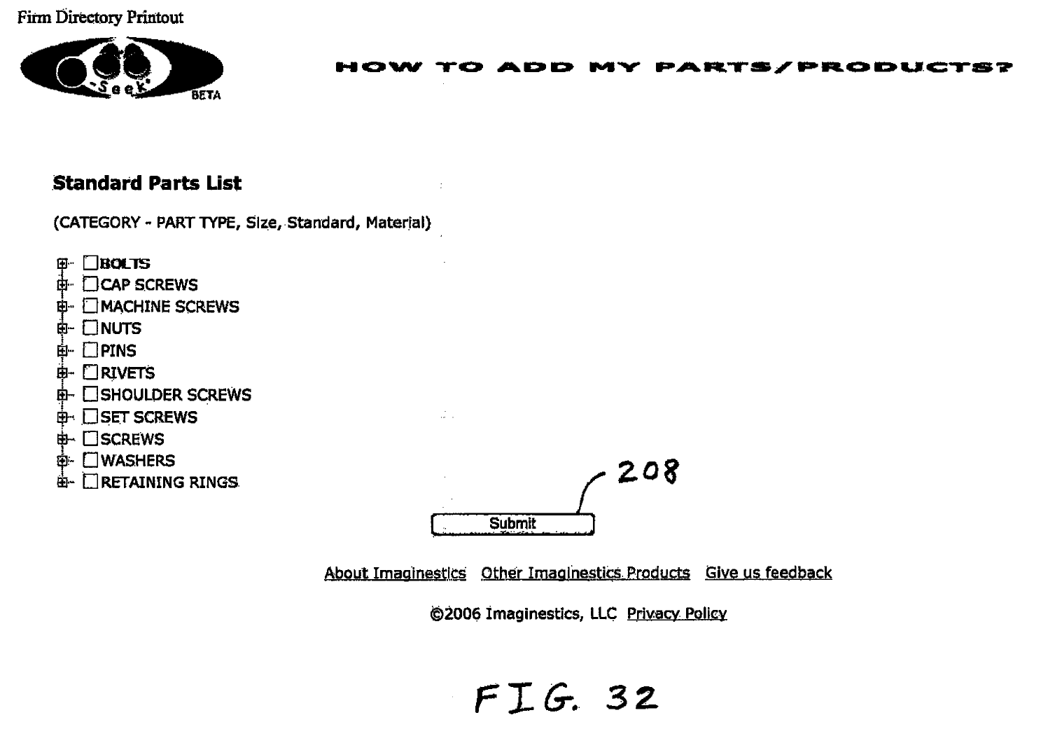

If the supplier does not have electronic part files on his web site, then he may click on a “I do not have electronic part files” link 196 (FIG. 17a), which may take him to the web page of FIG. 31. The supplier may then click on the “Select parts from the standard parts list” link 212 to thereby be taken to the web page of FIG. 32. After selecting one or more of the part categories listed in FIG. 32, the supplier may click on a Submit icon 208, and the supplier may be taken to the web page shown in FIG. 30. After filling in the fields in FIG. 30, the supplier may click on Submit icon 210 to thereby complete the registration.

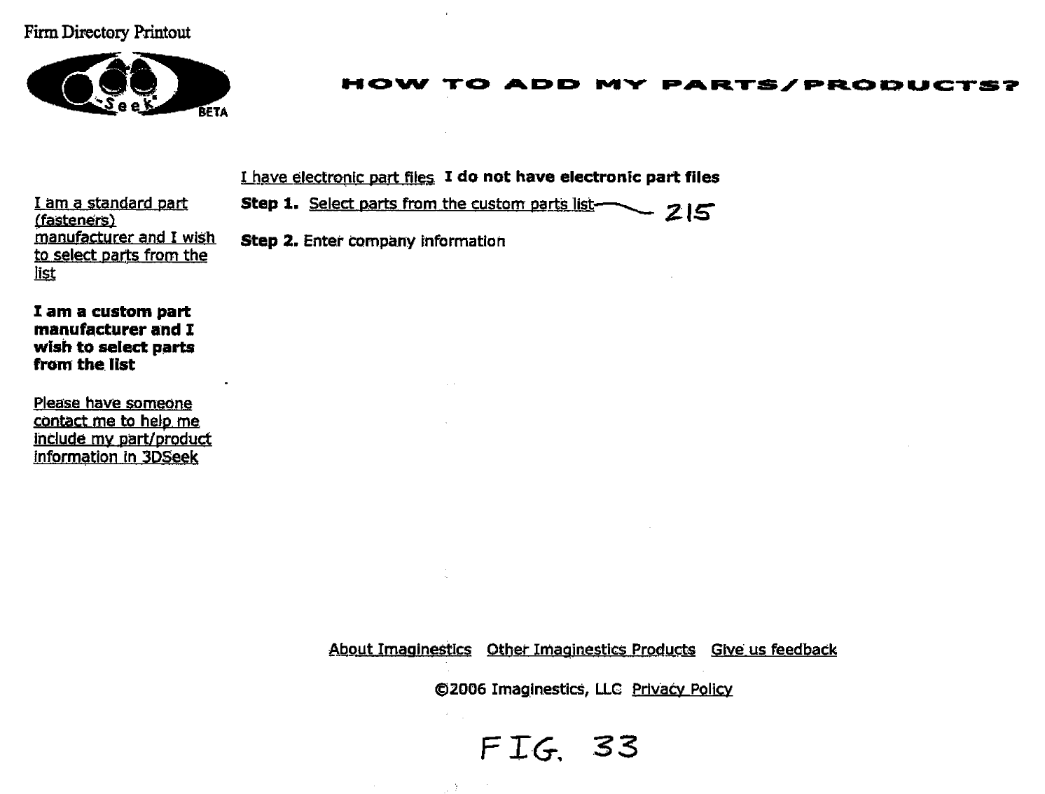

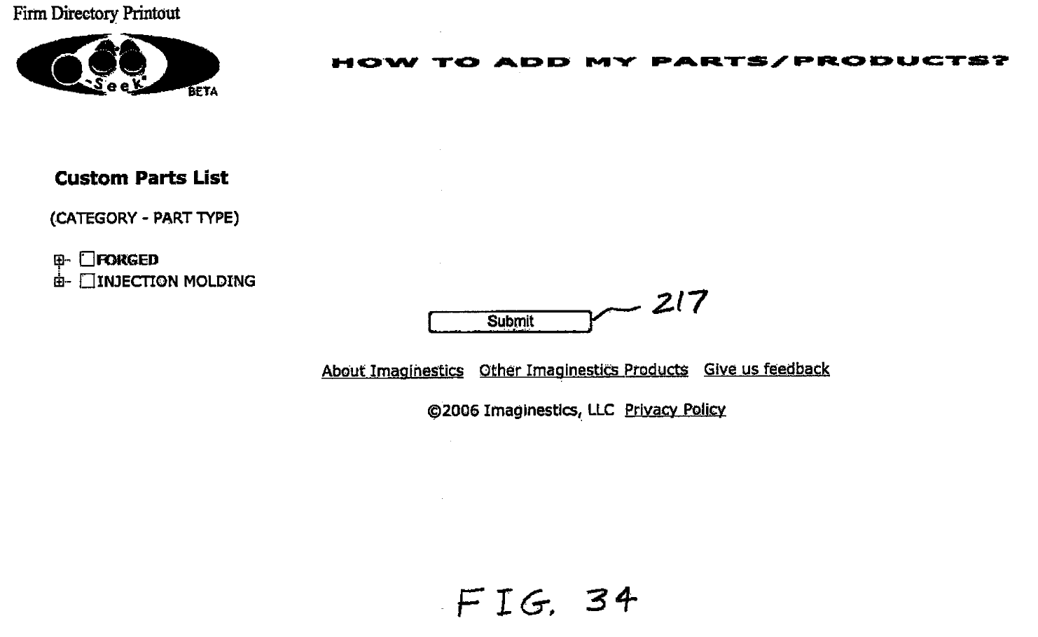

At the web page of FIG. 31, the supplier may also click on link 213 to thereby be taken to the web page of FIG. 33. The supplier may then click on the “Select parts from the custom parts list” link 215 to thereby be taken to the web page of FIG. 34. After selecting one or more of the part categories listed in FIG. 34, the supplier may click on a Submit icon 217, and the supplier may be taken to the web page shown in FIG. 30. After filling in the fields in FIG. 30, the supplier may click on Submit icon 210 to thereby complete the registration.

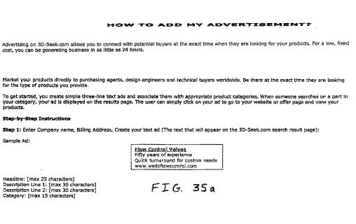

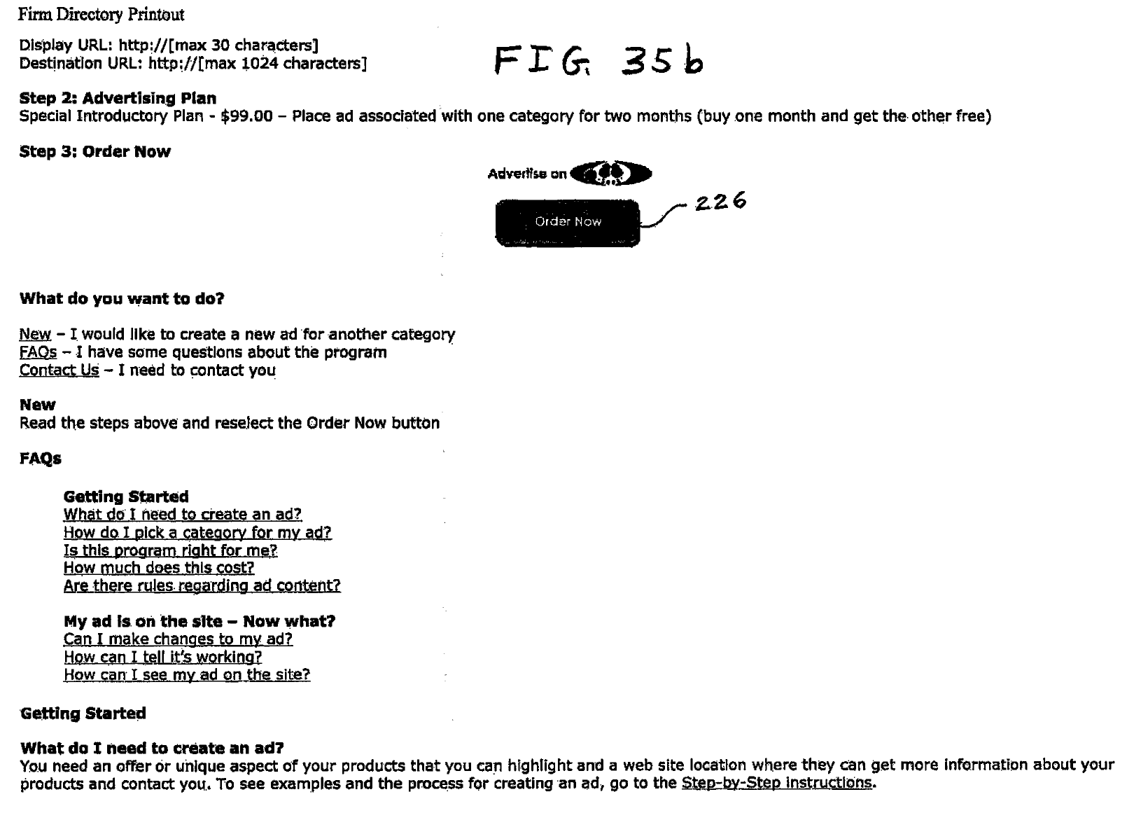

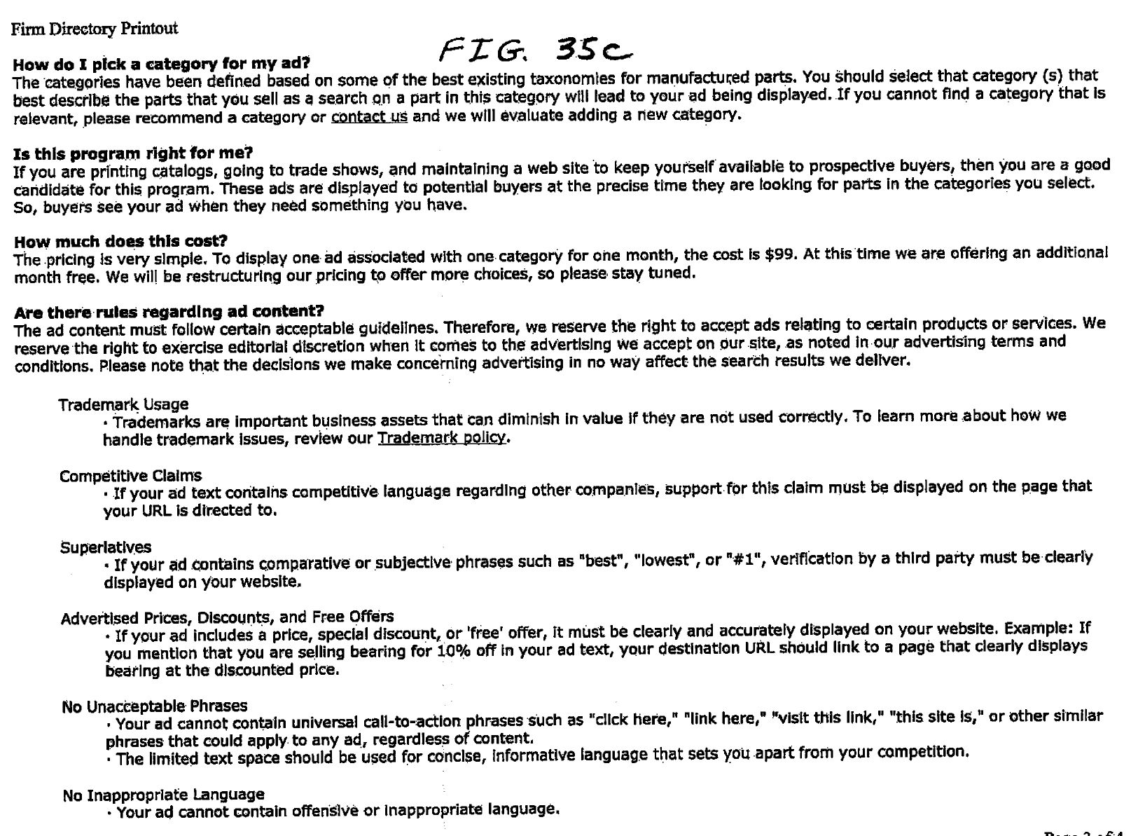

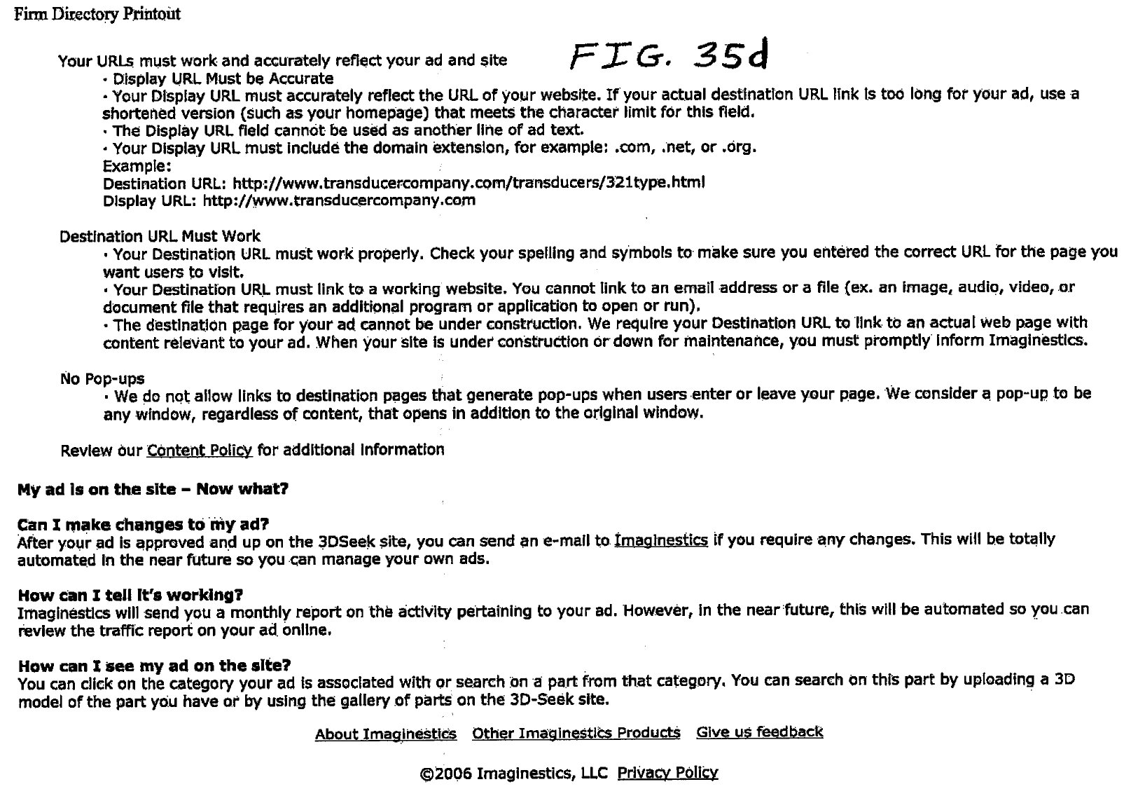

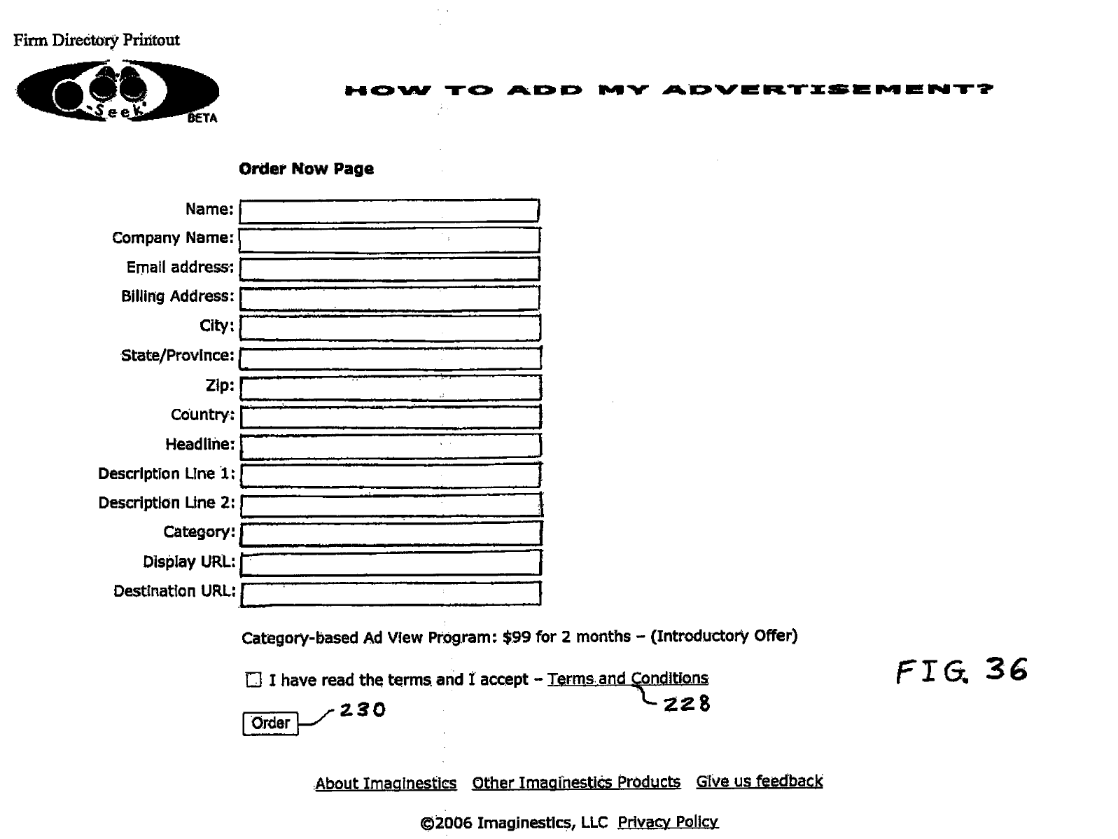

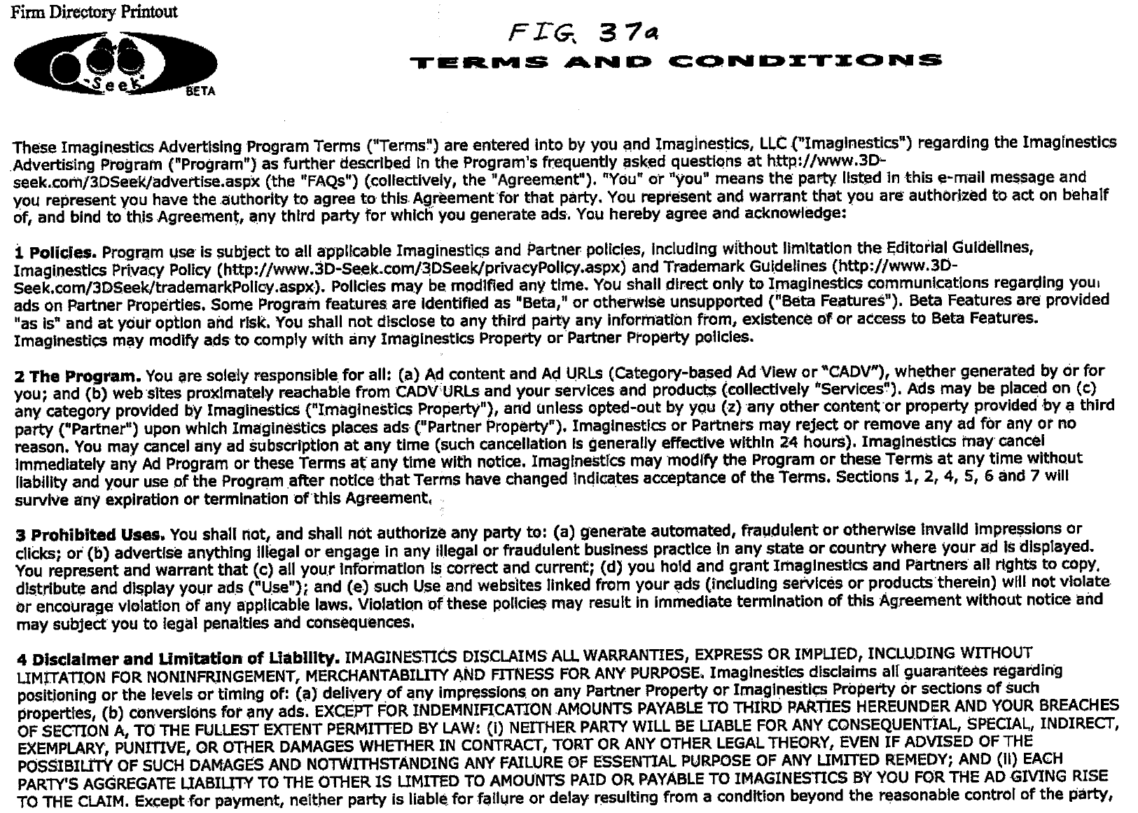

In addition to, or as an alternative to, adding his parts to the database, a part supplier type of user may also click on a How to advertise? link 224 on the web page of FIG. 1, and may then be taken to the web page of FIGS. 35a-d. The supplier may click on an Order Now icon 226 to be taken to the web page of FIG. 36. The user may click on a Terms and Conditions link 228 to be taken to the web page of FIGS. 37a-b. After the user has returned to the web page of FIG. 36 and has filled in the fields in FIG. 36, he may click on an Order icon 230.

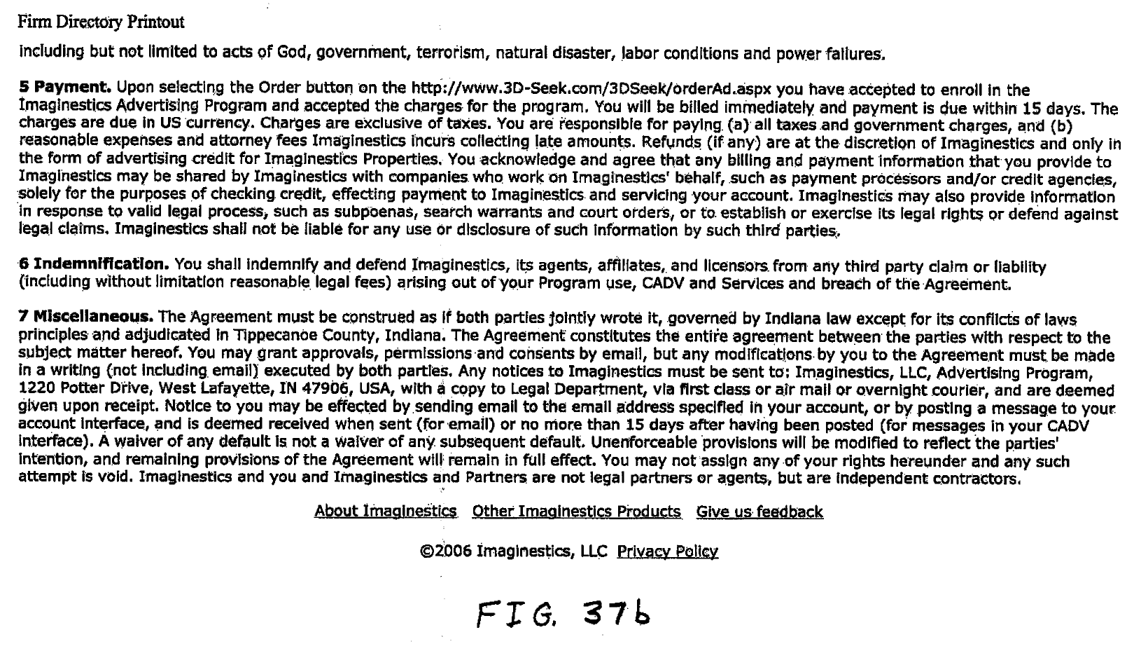

In addition to, or as another alternative to, adding parts to the database, and clicking on How to advertise? link 224, a user may also click on a “Refer site to your supplier” link 232 on the web page of FIG. 1, and may then be taken to the web page of FIG. 38. After filling in the fields of FIG. 38, the user may click on a Send Email icon 234 to thereby send an email to the user's supplier. The email may identify the sender of the email as the supplier's customer/prospect, make the supplier aware of the web site, provide an electronic link to the web site, and explain the advantages to the supplier of registering his parts on the web site.

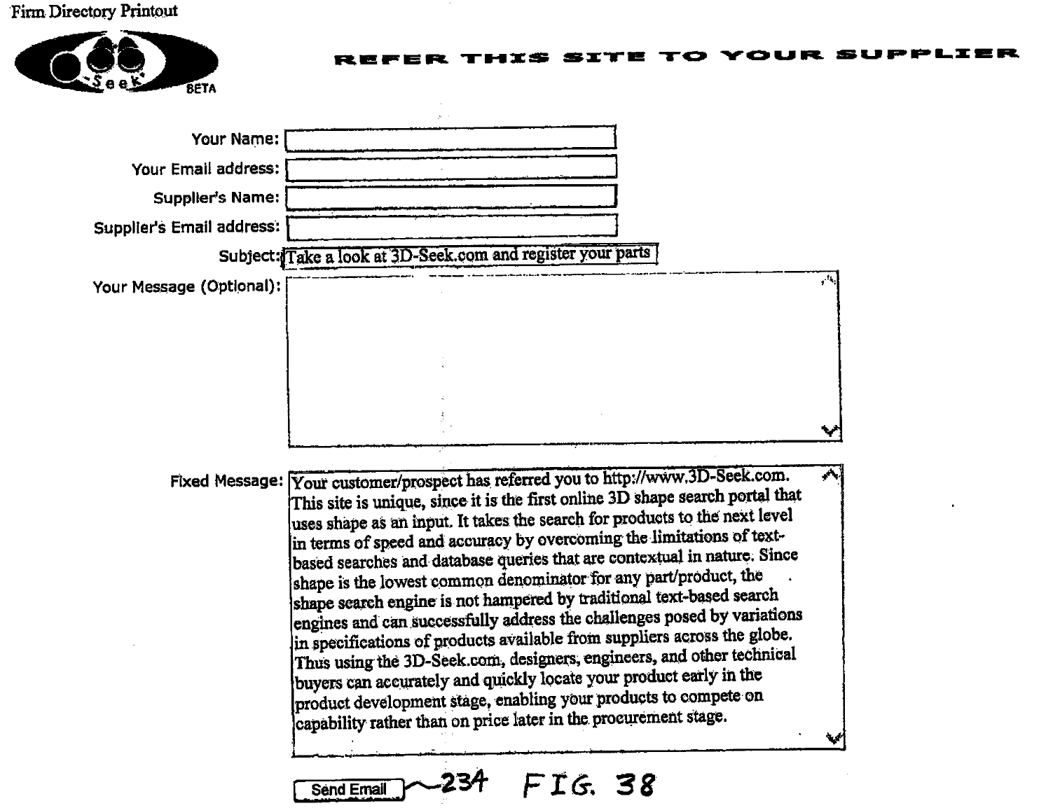

Shown in FIG. 39 is one embodiment of a networked computer system 236 of the present invention which is suitable for implementing one or more of the methods of the present invention. System 236 includes a server 238 connected to the Internet 240, also known as the world wide web. Also connected to the Internet 240 are vendor computers 242₁, 242₂, . . . , 242ₙ. Further connected to the Internet 240 are purchaser computers 244₁, 244₂, . . . , 244ₘ. Connected to each purchaser computer 244 is a respective monitor 246 and a respective mouse or pen device 248. Server 238 may include a rasterization engine 250, a search engine 252, and an image database 254.

Image database 254 may include a compilation of vendor image data that is received, such as via i-prowler software and Internet 240, from vendors 242. Input image data may be received in search engine 252 from purchaser computers 244 via Internet 240. The purchaser may upload input image data of a component that he is seeking to search engine 252, may draw input image data on monitor 246 by use of a mouse or pen device 248, or some combination of the two. Further, the purchaser may create input image data by drawing on an image retrieved from database 254.

Based upon the input image data, search engine 252 may find matching or at least similar vendor image data in image database 254. Rasterization engine 250 may process the matching vendor image data so that a matching vendor image may be displayed on monitor 246. Rasterization engine 250 may also process three-dimensional image data such that monitor 246 may display images based thereon from any possible viewpoint in three-dimensional space. Further, rasterization engine 250 may enable the image displayed on monitor 246 to be continuously updated as the purchaser rotates the displayed image about any axis he desires. The purchaser may view search result images on monitor 246, modify the search result images with mouse/pen 248, and request new search results based upon the modified images. The purchaser may continue the cycle of receiving search results, modifying the resulting images, and requesting new search results based thereon with as many iterations as he desires.

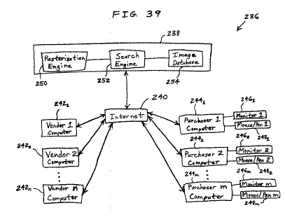

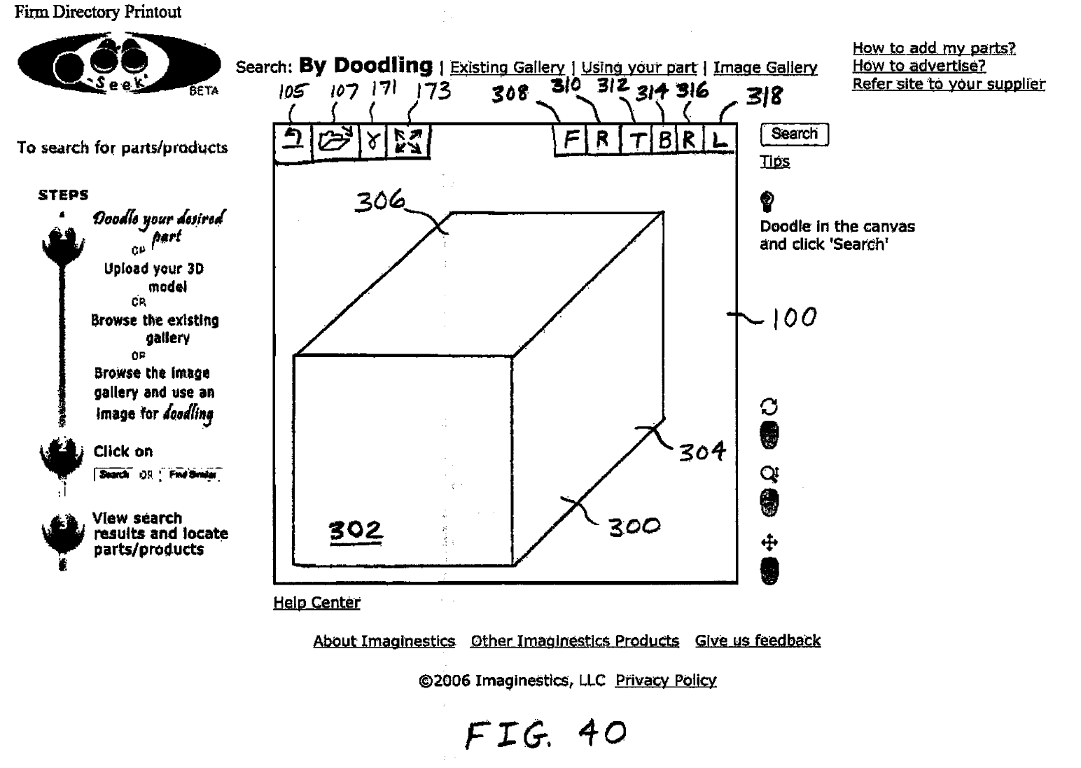

In another embodiment, shown in FIGS. 40-47, the user is presented with a three-dimensional input canvas, drawing cube tool, input image space or “cubic” 300, which may or may not be provided within a conventional canvas 100 as shown. Cubic 300 is a six-sided canvas, of which a front face 302, a right face 304 and a top face 306 are visible in FIG. 40. Each of the six faces of cubic 300 may present a component part with cubic 300 at a respective orthographic viewpoint. However, it is also possible for each of the six faces of cubic 300 may present a component part with cubic 300 at a respective perspective viewpoint. The user may doodle his desired part in one, two, three, four, five or six of the faces of cubic 300 and then request a search based thereon. Alternatively, the user may upload his own image data into cubic 300 and doodle thereupon in order to create input for the search. As another alternative, the user may retrieve image data from the database for display in cubic 300, and may then doodle upon those images in order to create input for the search.

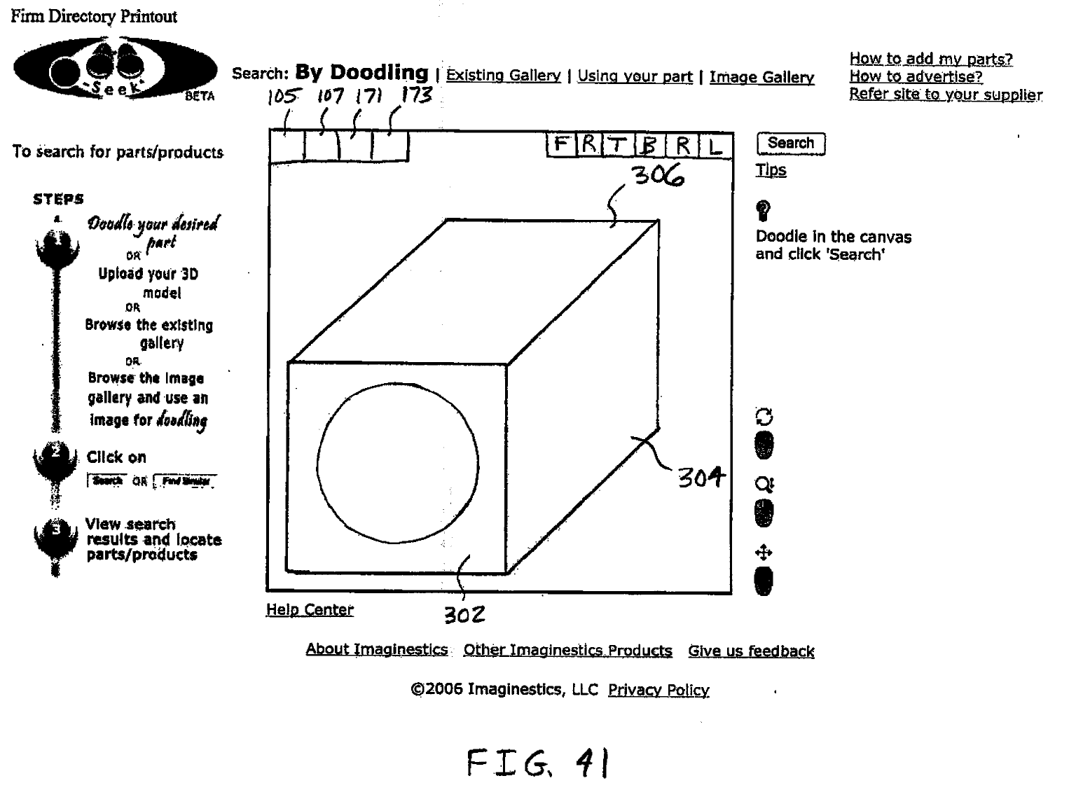

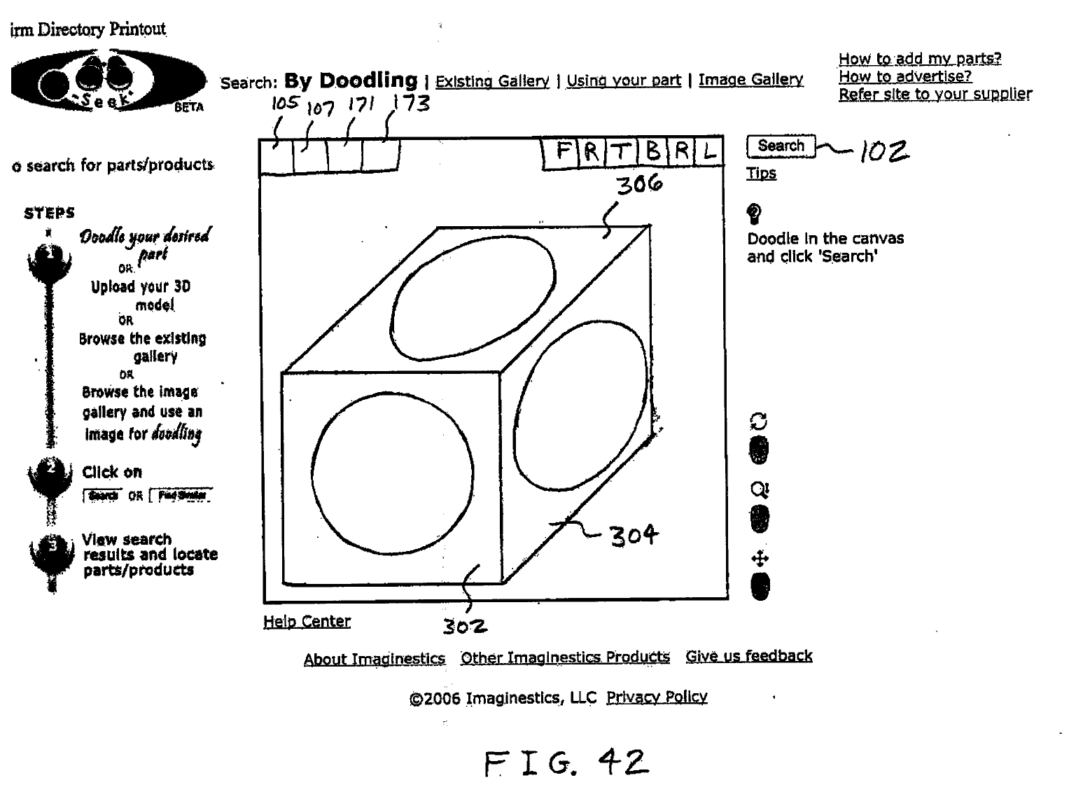

In the simple example of FIGS. 41-45, the user doodles a part in the shape of a sphere, such as a ball bearing, into cubic 300. In FIG. 41, the user begins by drawing a circle in front face 302. The user may then draw a side view of the sphere in face 304 and a top view of the sphere in face 306, as shown in FIG. 42, wherein the sphere appears as an ellipse from the right and top perspectives. It is possible for the user to request a search based upon one, two, three, four, five or six views entered into cubic 300. Thus, it is possible in FIG. 42 for the user to request a search by clicking on Search icon 102. However, it is also possible for the user to further doodle in any or all of the three remaining faces before requesting a search, as will be clearer after the discussion below.

The user may find it easiest to doodle on a face when he views the face from a perpendicular angle, as he does front face 302 in FIGS. 40-42. Thus, the user may click on any of a front face icon 308, a rear face icon 310, a top face icon 312, a bottom face icon 314, a right face icon 316 or a left face icon 318 in order to cause that particular face to be oriented perpendicularly to the direction of view. For example, after drawing in the circle and two ellipses in FIG. 42, the user may click on right face icon 316 to orient cubic 300 as shown in FIG. 43, wherein the user may more easily doodle any modifications in right face 304. The user may further doodle modifications onto the ellipse in top face 306 as shown in FIG. 43, or the user may click on top face icon 312 so that the top view is presented as a circle, which he may be able to more easily modify.

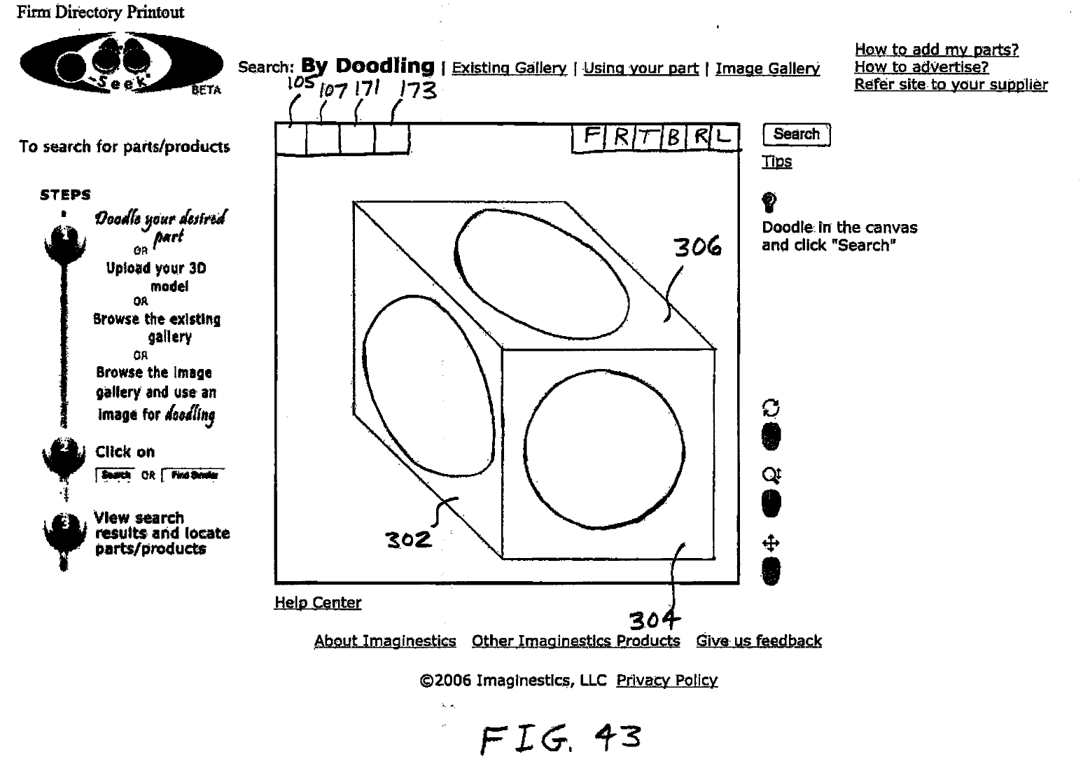

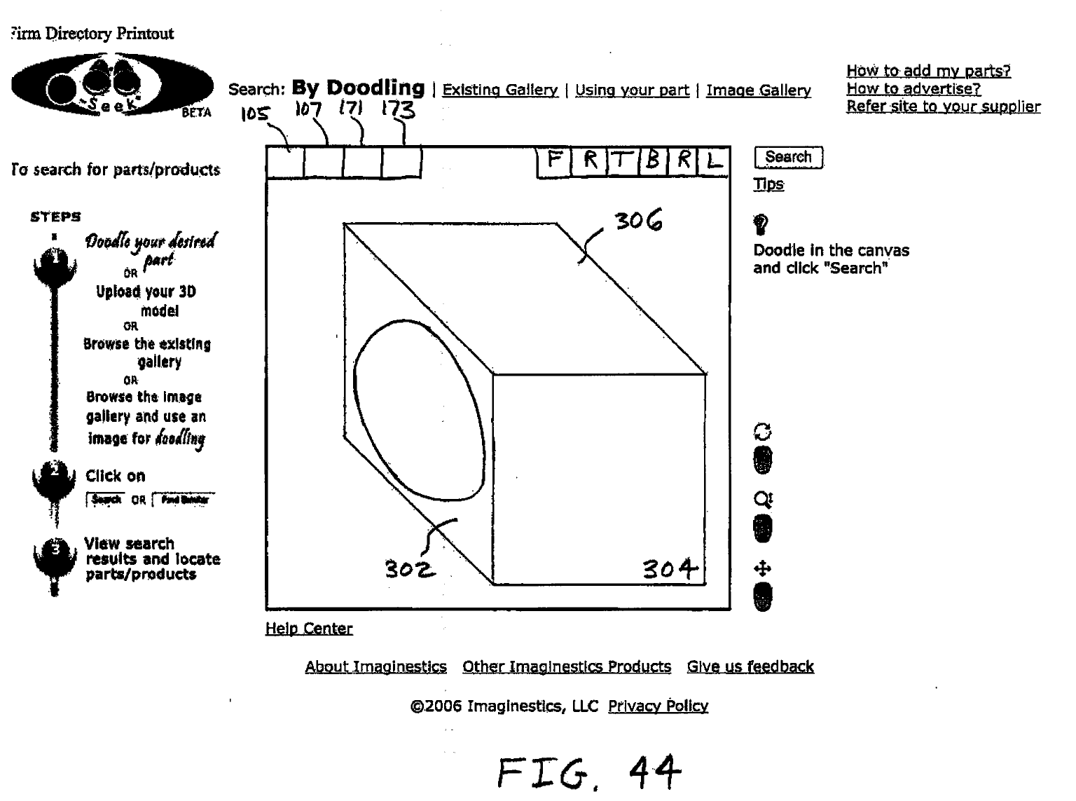

Instead of drawing ellipses, the user, after drawing the circle in FIG. 41, may immediately click upon right face icon 316 to orient cubic 300 as shown in FIG. 44. The user may then simply doodle a circle in right face 304 before either drawing an ellipse in top face 306 or clicking on top face icon 312 in order to draw a circle in top face 306. Alternatively, the user, after drawing the circle in FIG. 41, may immediately click upon top face icon 312 to orient cubic 300 as shown in FIG. 45. The user may then simply doodle a circle in top face 306 before either drawing an ellipse in right face 304 or clicking on right face icon 316 in order to draw a circle in right face 316. It is to be understood that a search may be requested at any point after doodling one or more views onto cubic 300

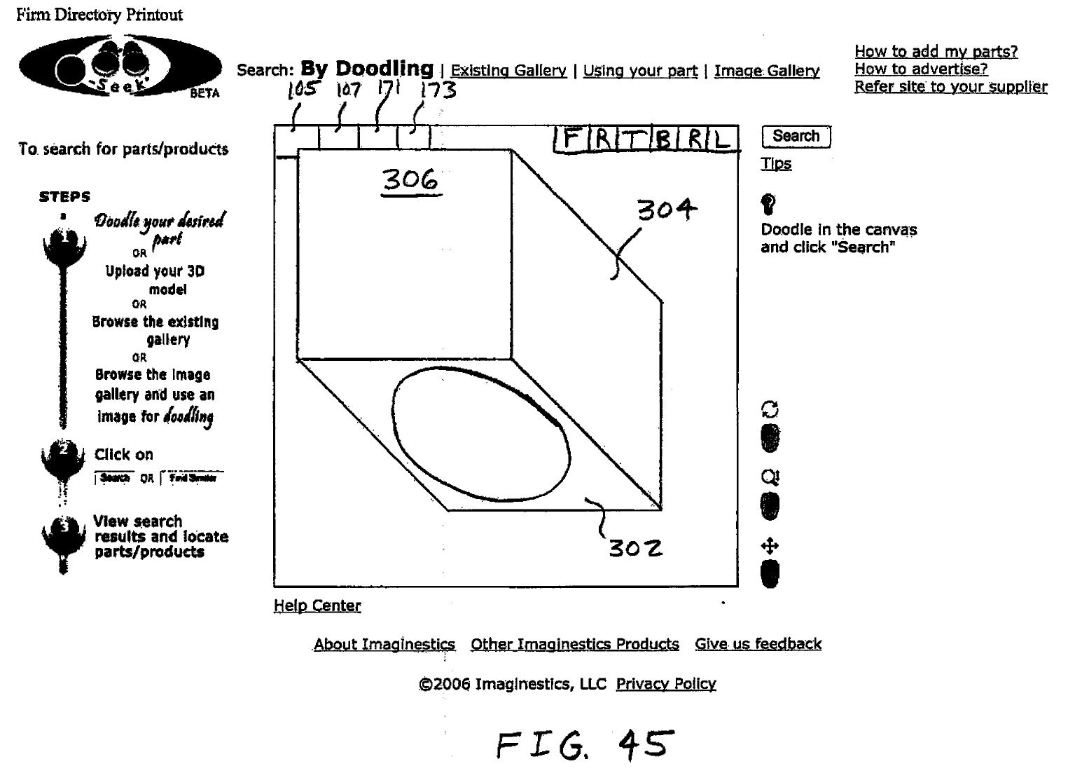

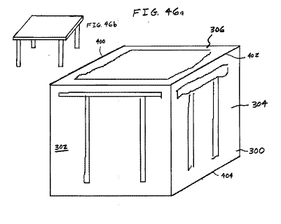

The slightly more complex example of a table doodled into cubic 300 is shown in FIG. 46a. A perspective view of the table is provided in FIG. 46b in order to make clear to the reader of this document what the table may look like. However, the perspective view may not be employed in any way in the invention itself.

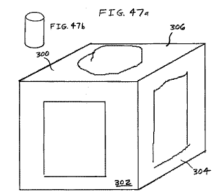

Another example including a cylinder doodled into cubic 300 is shown in FIG. 47a. Again, a perspective view of the cylinder is provided in FIG. 47b in order to make clear to the reader of this document what the cylinder may look like. However, the perspective view may not be employed in any way in the invention itself.

As made clear in FIGS. 46-47, it is possible for all six faces of cubic 300 to be square-shaped. That is, all twelve edges of cubic 300 may be substantially equal in length. Of course, when viewed in perspective, the edges 400, 402, 404 extending away from the viewer may be provided with shorter lengths on the screen because of the viewing angle.

It is also possible for each of the six faces to be color coded so that the user may more easily keep track of which viewpoint he is looking at the part from. For example, the front face may be outlined in red, the right face outlined in green, etc. Further, these respective colors may be included in icons 308-318 for additional user friendliness.

It has been found that the natural inclination of a user is to draw a part as he sees it, i.e., in a perspective view. However, search engines are better able to process orthographic views than perspective views. The embodiment of FIGS. 40-47 has the advantage of forcing the user to think in terms of orthographic views, and to draw orthographic views as input for the search, which may lead to better search results.

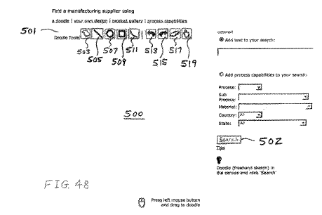

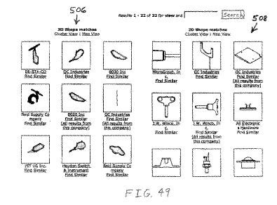

FIG. 48 illustrates a page of another embodiment of a web site that may be used to implement the method of the present invention. The web page, which may appear on a user's monitor, includes a canvas 500 having vertical and horizontal gridlines. Within canvas 500, a user may doodle, sketch or draw a desired component, i.e., “part”, that he would like to find, locate, or obtain. Toolbar 501 includes a Doodle icon 503, a Straight Line Drawing icon 505, a Circle Drawing icon 507, a Rectangle Drawing icon 509, an Arc Drawing icon 511, an Undo icon 513, a Redo icon 515, an Erase icon 517, and a Select icon 519. Clicking on icons 505, 507, 509 and 511 enables a user to draw a line, circle, rectangle and arc, respectively, by selecting two or three defining points.

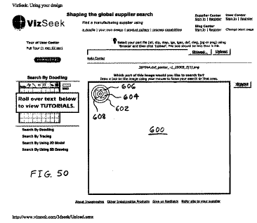

After the user has drawn an image on canvas 500 and clicked on search icon 502, the server may respond with a web page having a format similar to that shown in FIG. 49. The web page may provide a list of search results including component images divided between three-dimensional shapes 506 and two-dimensional shapes 508.

FIG. 50 is a web page similar to the web page of FIG. 14c that enables a user to upload a selected image file onto canvas 600. The web page of FIG. 50 has the additional feature of enabling the user to draw a rectangle or “box” 604 on a particular section of an uploaded image 602 to focus the ensuing search on the boxed area. The box may be any size of the user's choosing, as the user defines the box by selecting two points, such as points 606, 608, as opposite corners of the box. The search that is performed for similar images in the database may give additional weight or consideration to matching the boxed section of the image.

While this invention has been described as having an exemplary design, the present invention may be further modified within the spirit and scope of this disclosure. This application is therefore intended to cover any variations, uses, or adaptations of the invention using its general principles.

What is claimed is:

1. A method of receiving input image data for an image search engine, said method comprising:
providing a two-dimensional input image on a display screen;
enabling a user to rotate the input image on the display screen about an axis that is non-perpendicular to a plane of the input image; and
enabling the user to electronically draw modifications on the rotated input image.

2. The method of claim 1 wherein the providing step comprises receiving a two-dimensional input image that is electronically drawn on the display screen by the user.

3. The method of claim 1 wherein the providing step comprises receiving a two-dimensional input image that is based upon three-dimensional image data uploaded from a user's computer.

4. The method of claim 1 wherein the providing step comprises:
retrieving a two-dimensional image from a database; and
receiving modifications to the two-dimensional image, the modifications being electronically drawn on the display screen by the user.

5. The method of claim 1 wherein the axis is parallel to the plane of the input image.

6. The method of claim 1 wherein the axis comprises a vertical axis.

7. The method of claim 1 wherein the rotated input image is provided by a rasterization engine based upon three-dimensional image data stored in a database.

8. The method of claim 1 comprising the further step of transmitting the two-dimensional input image and the modified rotated input image to a three-dimensional image search engine.

9. The method of claim 1 comprising the further steps of:
enabling a user to rotate the modified rotated input image on the display screen about a second axis that is non-perpendicular to the plane of the input image and non-perpendicular to the plane of the modified rotated input image; and
enabling the user to electronically draw modifications on the twice-rotated input image.

10. The method of claim 1 comprising the further step of transmitting the two-dimensional input image, the modified rotated input image, and the modified twice-rotated input image to a three-dimensional image search engine.

11. The method of claim 1 comprising the further step of enabling the user to electronically draw hidden features in phantom lines on the input image.

12. A method of providing an electronic commercial showplace, comprising the steps of:
providing a database of image data associated with component parts;
enabling a plurality of vendors to upload image data to the database via a web site, the uploaded image data being associated with component parts that are sold by the vendors;
enabling a purchaser to enter image data onto a web site, the image data representing a component that the purchaser would like to buy;
searching the database for vendor image data matching the purchaser image data;
displaying a matching vendor image to the purchaser on the web site; and
displaying vendor information to the purchaser on the web site, the vendor information being associated with the matching vendor image data.

13. The method of claim 12 wherein the image data is at least partially entered by electronic drawing of the component by the purchaser on a display screen.

14. The method of claim 12 wherein the vendor information facilitates a sale to the purchaser of a component part associated with the matching vendor image data.

15. The method of claim 12 wherein the vendor information includes at least one of:
a link to a web site of the vendor;
an indication of whether the component part is a stock part;
a text descriptor of the component part;
a model number of the component part; and
a web-based link enabling the purchaser to download image files associated with the component part.

16. The method of claim 12 comprising the further steps of:
enabling the purchaser to electronically sketch modifications onto the displayed matching vendor image;
searching the database for second vendor image data matching the modified vendor image;
displaying a matching second vendor image to the purchaser on the web site; and
displaying second vendor information to the purchaser on the web site, the second vendor information being associated with the matching second vendor image data.

17. The method of claim 12 comprising the further steps of:
enabling a user to rotate the displayed matching vendor image on the display screen about an axis that is non-perpendicular to a plane of the displayed matching vendor image;
enabling the purchaser to electronically sketch modifications onto the displayed matching vendor image;
searching the database for second vendor image data matching the modified matching vendor image;
displaying the matching second vendor image data to the purchaser on the web site; and
displaying second vendor information to the purchaser on the web site, the second vendor information being associated with the matching second vendor image data.

18. The method of claim 12 wherein the purchaser's e-mail address is forwarded to the vendor in the event of the user indicating interest in the vendor image.

19. A method of receiving input image data for an image search engine, said method comprising:
providing a two-dimensional representation of a three-dimensional cubic shape on a display screen, the representation including three faces oriented substantially perpendicular to each other; and
enabling a user to draw:
a first orthographic view of an object onto a first of the faces; and
a second orthographic view of the object onto a second of the faces.

20. The method of claim 19 wherein the enabling step includes enabling the user to draw a third orthographic view of the object onto a third of the faces.
